(19) United States
(12) Patent Application Publication
(10) Pub. No.: US 2014/0170544 A1
(43) Pub. Date: Jun. 19, 2014

(54) ELECTROPHOTOGRAPHIC PHOTOCONDUCTOR AND METHOD FOR PRODUCING THE SAME

(71) Applicants: Yoshiaki Kawasaki, Shizuoka (JP); Hongguo Li, Shizuoka (JP); Tomohiro Hirade, Shizuoka (JP)

(72) Inventors: Yoshiaki Kawasaki, Shizuoka (JP); Hongguo Li, Shizuoka (JP); Tomohiro Hirade, Shizuoka (JP)

(21) Appl. No.: 14/233,586

(22) PCT Filed: Jul. 18, 2012
(86) PCT No.: PCT/JP2012/068746

§ 371 Date: Jan. 17, 2014

(30) Foreign Application Priority Data
Jul. 19, 2011 (JP) 2011-157428
Jun. 14, 2012 (JP) 2012-134478

(51) Int. Cl. G03G 5/043

(52) U.S. Cl. CPC G03G 5/043
USPC 430/66; 430/130

(57) ABSTRACT

An electrophotographic photoconductor including: an electroconductive substrate; a photoconductive layer; and a surface layer, the photoconductive layer and the surface layer being laid over the electroconductive substrate, wherein the surface layer is a crosslinked layer which is cured by irradiating with light energy a composition containing a radical polymerizable monomer having no charge transporting structure, a radical polymerizable compound having a charge transporting structure and a photopolymerization initiator, and wherein the radical polymerizable compound having a charge transporting structure has a ratio Ae/As of 0.7 or higher where Ae denotes absorbance at an absorption peak wavelength λ after the radical polymerizable compound having a charge transporting structure is irradiated with light energy and As denotes absorbance at an absorption peak wavelength λ before the radical polymerizable compound having a charge transporting structure is irradiated with light energy.

### TECHNICAL FIELD

The present invention relates to an electrophotographic photoconductor containing a surface layer crosslinked or cured through irradiation of light energy, and to a method for producing the electrophotographic photoconductor.

### BACKGROUND ART

By virtue of their good performances and various advantages, organic photoconductors (OPCs) have recently been used in a lot of copiers, facsimiles, laser printers and complex machines thereof, in place of inorganic photoconductors. The reason for this includes: (1) excellent optical characteristics such as wide light absorption wavelength range and large light absorption amount; (2) excellent electrical characteristics such as high sensitivity and stable chargeability; (3) a wide range of materials usable; (4) easiness in production; (5) low cost; and (6) non-toxicity.

Also, in an attempt to downsize image forming apparatuses, photoconductors have recently been downsized more and more. In addition, to make the image forming apparatuses operate at higher speed and free of maintenance, keen demand has arisen for photoconductors having higher durability. From this viewpoint, the organic photoconductors have a surface layer mainly containing a low-molecular-weight charge transporting compound and an inert polymer and thus are soft in general. When repetitively used in the electrophotographic process, the organic photoconductors disadvantageously tend to be abraded due to mechanical load given by the developing system or cleaning system. Moreover, toner particles have had smaller and smaller particle diameters to meet the requirements for high-quality image formation. To improve cleanability of such small toner particles, the hardness of the rubber of a cleaning blade must be increased and also the contact pressure between the cleaning blade and the photoconductor must be increased. This is another cause of accelerating abrasion of the photoconductor. Such abrasion of the photoconductor degrades sensitivity and electrical characteristics such as chargeability, causing a drop in image density and forming abnormal images such as background smear. Also, locally abraded scratches lead to cleaning failures to form images with streaks of stain. At present, the service life of the photoconductor depends on the abrasion and scratches, resulting in replacement of the photoconductor.

Thus, for enhancing the durability of the organic photoconductor, it is indispensable to reduce the abrasion amount of the organic photoconductor. The reduction of the abrasion amount is the most urgent object to be achieved in this technical field.

Examples of the techniques of improving the abrasion resistance of the photoconductor include: (1) a technique of using a curable binder in a surface layer (see PTL 1); (2) a technique of using a charge transporting polymer (see PTL 2); and (3) a technique of dispersing an inorganic filler in a surface layer (see PTL 3).

Among these techniques, in the photoconductor formed by the technique (1) using the curable binder, the binder resin is poor in compatibility with the charge transporting compound and thus impurities such as a polymerization initiator and unreacted residues elevate the residual potential of the photoconductor, so that the image density tends to decrease.

The photoconductor formed by the technique (2) using the charge transporting polymer and the photoconductor formed by the technique (3) of dispersing the inorganic filler are able to be improved in abrasion resistance to some extent; however, these photoconductors cannot have satisfactory durability required for organic photoconductors.

In the photoconductor formed by the technique (3) containing the inorganic filler dispersed therein, the surface of the inorganic filler traps charges to increase the residual potential and the image density tends to decrease.

Therefore, the techniques of (1), (2) and (3) cannot provide organic photoconductors that satisfy general durabilities including electrical durability and mechanical durability required for them.

Furthermore, for improving abrasion resistance and scratch resistance of the photoconductor formed by the technique (1), there has been proposed a photoconductor containing a cured product of a polyfunctional acrylate monomer (see PTL 4). This literature describes that the cured product of the polyfunctional acrylate monomer is incorporated into a protective layer provided on a photoconductive layer and also describes that a charge transporting compound may be incorporated into the surface layer. However, there is no specific description about it, and when a low-molecular-weight charge transporting compound is simply incorporated into the surface layer, the charge transporting compound raises a problem in terms of compatibility with the above cured product. As a result, the precipitation of the low-molecular-weight charge transporting compound and the cloudiness occur and also the mechanical strength is degraded in some cases. Moreover, since this photoconductor is formed by allowing monomers to react in the state where the polymer binder is present, the curing does not proceed sufficiently, and the cured product is poor in compatibility with the binder resin. As a result, surface irregularities are formed due to phase separation during curing, causing cleaning failures.

As an alternative method of these techniques of improving abrasion resistance of the photoconductive layer, there has been proposed a technique of providing a charge transporting layer formed by using a coating liquid containing a monomer having a carbon-carbon double bond, a charge transporting compound having a carbon-carbon double bond, and a binder resin (see PTL 5). The binder resin includes: a binder resin having a carbon-carbon double bond and having reactivity with the charge transporting compound; and a binder resin having neither carbon-carbon double bond nor reactivity with the charge transporting compound. This photoconductor attracts attention since it can achieve good abrasion resistance and good electrical properties.

However, when a binder resin having no reactivity is used, the compatibility is poor between the binder resin and the cured product obtained through reaction between the above monomer and the charge transporting compound, causing phase separation which leads to formation of surface irregularities upon crosslinking and hence to cleaning failures. In this case, as described above, the binder resin prevents curing of the monomer. In addition, the number of functional groups of the difunctional monomer used in this photoconductor is small and thus satisfactory crosslinking density cannot be obtained, resulting in that the photoconductor is not satisfactory in terms of abrasion resistance. Even when a binder resin having reactivity with the charge transporting compound is used, since the number of functional groups contained in the monomer and the binder resin is small, it is difficult to achieve both satisfactory amount of the charge transporting compound bonded and the crosslinking density, and the electrical properties and abrasion resistance of the obtained photoconductor are not satisfactory.

Furthermore, there is known a photoconductive layer containing a cured product of a charge transporting compound having two or more chain-polymerizable functional groups in one molecule thereof (see PTL 6).

This photoconductive layer is formed using a bulky charge transporting compound having two or more chain-polymerizable functional groups in one molecule thereof. Thus, the cured product is strained and has high internal stress, which leads to roughening the surface layer and formation of cracks as time passes. As a result, the obtained photoconductor does not have satisfactory durability.

In an attempt to overcome the above-described problems, it was found that electrical properties and abrasion resistance could be improved by providing as a surface layer a crosslinked resin layer which is cured by applying light energy to at least a radical polymerizable monomer having no charge transporting structure and a radical polymerizable compound having a charge transporting structure (see, for example, PTLs 7 to 9).

The light energy commonly used is ultraviolet light emitted from a UV lamp, but the light energy emitted from the UV lamp contains light energy having unnecessary wavelengths. In particular, light energy having light emission wavelengths in the infrared region applies a large amount of heat to the substrate and allows the crosslinking reaction to rapidly proceed, greatly changing the surface properties to easily form surface irregularities.

As a result, the obtained photoconductor easily involves cleaning failures. When it is used for a long period of time, the cleaning blade is locally cracked to cause cleaning failures, leading to formation of streaky abnormal images.

Also, the rapid crosslinking reaction results in increased internal stress. As a result, when the surface layer is abraded to the charge transport layer after long-term use, the surface layer is delaminated and then abrasion proceeds rapidly to cause background smear. In an attempt to overcome such a problem, there has been conceived a method where a support is cooled to suppress rapid crosslinking reaction (see PTLs 10 and 11).

Another problem of the crosslinked resin film formed through irradiation with light energy is that the surface thereof differs in cure degree from the inner portion thereof, which leads to degradation of abrasion resistance. The absorption wavelength of the radical polymerizable compound having a charge transporting structure is close to that of the photopolymerization initiator. Therefore, the required light energy for generating radicals is absorbed by the radical polymerizable compound having a charge transporting structure and does not reach the inner portion of the surface layer. As a result, the inner portion is cured insufficiently as compared with the surface, causing variation in cure degree leading to degradation of abrasion resistance.

In order to solve this problem, it is necessary to apply such an excessive amount of light energy that reaches the polymerization initiator present in the inner portion of the surface layer to thereby sufficiently cure the inner portion. However, when the radical polymerizable compound having a charge transporting structure is exposed to excessive light energy for a long period of time, the radical polymerizable compound having a charge transporting structure is degraded to cause degradation in electrical properties of the obtained electrophotographic photoconductor.

Moreover, there is described a photoconductor having improved surface smoothness and electrical properties, which has a surface layer the inner portion of which is crosslinked uniformly with the surface thereof by irradiating a compound absorbing light of 400 nm or higher (serving as a photopolymerization initiator) with light that has not been absorbed by the radical polymerizable compound having a charge transporting structure; i.e., light having transmitted the absorption wavelength region of the radical polymerizable compound having a charge transporting structure (see, for example, PTL 12).

However, since this photoconductor is formed using a UV irradiation light source that emits light of a wide wavelength region, such as a high-pressure mercury lamp and a metal halide lamp, the radical polymerizable compound having a charge transporting structure cannot satisfactorily be prevented from being degraded. Furthermore, the amount of the photopolymerization initiator contained cannot be reduced in order to prevent degradation of the radical polymerizable compound having a charge transporting structure. Thus, the amounts of the radical polymerizable monomer and the charge transport compound contained in the crosslinked surface layer substantially decrease, and the photopolymerization initiator remains to potentially make the inner portion of the crosslinked surface layer ununiform. As a result, the photoconductor does not satisfactory abrasion resistance and prevention of increase in residual potential.

Also, there is proposed that the peak wavelength of a LED light source is adjusted to overlap the peak wavelength of the photopolymerization initiator (see, for example, PTL 13) (a charge transporting compound is not contained).

By selecting the light-emitting element of the LED, it is possible to allow the LED to emit light energy containing neither light of the infrared region, which is a source for generating heat, nor light of the absorption region of the radical polymerizable compound having a charge transporting structure.

However, the light emission wavelength region of the LED is very narrow, and the entire light energy thereof is very low as compared with that of a conventionally-used UV lamp having a wide light emission region. Thus, it is difficult for the LED to uniformly and sufficiently cure the surface and the inner portion of the surface layer containing the charge transporting compound. Furthermore, there is described that using a LED as a light source prevents failures in curing which would otherwise be caused due to oxygen (see, for example, PTLs 14 and 15). However, the failures due to oxygen occur the surface of the crosslinked surface layer and thus oxygen does not affect uniformity in curing in the inner portion thereof.

### CITATION LIST

### Patent Literature

PTL 1: Japanese Patent Application Laid-Open (JP-A) No. 56-48637
PTL 2: JP-A No. 64-1728
PTL 3: JP-A No. 04-281461
PTL 4: JP-A No. 08-262779 (Japanese Patent (JP-B) No. 3262488)
PTL 5: JP-A No. 05-216249 (JP-B No. 3194392)
PTL 6: JP-A No. 2000-66425
PTL 7: JP-A No. 2004-302450
PTL 8: JP-A No. 2004-302451
PTL 9: JP-A No. 2004-302452
PTL 10: JP-A No. 2007-322867
PTL 11: JP-A No. 2001-125297
PTL 12: JP-A No. 2010-164987
PTL 13: JP-A No. 2008-134505
PTL 14: JP-A No. 2012-002997
PTL 15: JP-A No. 2012-037749

### SUMMARY OF INVENTION

### Technical Problem

The present invention aims to provide an electrophotographic photoconductor the surface layer of which has good surface conditions and is uniform in the surface to the inner portion thereof, the electrophotographic photoconductor being stable with high abrasion resistance and scratch resistance, exhibiting good electrical properties and realizing high-quality image formation for a long period of time; and a method for producing the electrophotographic photoconductor.

### Solution to Problem

Means for solving the above problems are as follows.

An electrophotographic photoconductor of the present invention includes:

an electroconductive substrate;

a photoconductive layer; and

a surface layer,

the photoconductive layer and the surface layer being laid over the electroconductive substrate,

wherein the surface layer is a crosslinked layer which is cured by irradiating with light energy a composition containing a radical polymerizable monomer having no charge transporting structure, a radical polymerizable compound having a charge transporting structure and a photopolymerization initiator, and

wherein the radical polymerizable compound having a charge transporting structure has a ratio Ae/As of 0.7 or higher where Ae denotes absorbance at an absorption peak wavelength λ after the radical polymerizable compound having a charge transporting structure is irradiated with light energy and As denotes absorbance at an absorption peak wavelength λ before the radical polymerizable compound having a charge transporting structure is irradiated with light energy.

### Advantageous Effects of Invention

As can be understood from the below-described detail and specific description, the present invention can provide an electrophotographic photoconductor the surface layer of which has good surface conditions and is uniform in the surface to the inner portion thereof, the electrophotographic photoconductor being stable with high abrasion resistance and scratch resistance, exhibiting good electrical properties and realizing high-quality image formation for a long period of time.

### BRIEF DESCRIPTION OF DRAWINGS

FIG. 1 illustrates one exemplary method for directly irradiating a photoconductor drum with light energy from a LED light source, as viewed from the side surface of the photoconductor drum.

FIG. 2 illustrates one exemplary method for irradiating a photoconductor drum with light via a reflection plate from a LED light source, as viewed from the top surface of the photoconductor drum.

FIG. 3 is one exemplary cross-section of an electrophotographic photoconductor of the present invention.

FIG. 4 is another exemplary cross-section of an electrophotographic photoconductor of the present invention.

FIG. 5 schematically illustrates an electrophotographic photoconductor placed in a light energy irradiation vessel.

FIG. 6 is an absorption spectrum of a compound having Structural Formula C.

FIG. 7 is a wavelength spectrum of emission power of a LED having a light emission peak at 405 nm.

FIG. 8 is an absorption spectrum of photopolymerization initiator a.

FIG. 9 is a wavelength spectrum of emission power of a LED having a light emission peak at 395 nm.

FIG. 10 is a wavelength spectrum of emission power of a LED having a light emission peak at 365 nm.

FIG. 11 is an absorption spectrum of a compound having Structural Formula D.

FIG. 12 is an absorption spectrum of photopolymerization initiator b.

### DESCRIPTION OF EMBODIMENTS

### (Electrophotographic Photoconductor)

An electrophotographic photoconductor of the present invention will be specifically described.

The electrophotographic photoconductor of the present invention includes:

an electroconductive substrate;

a photoconductive layer; and

a surface layer,

the photoconductive layer and the surface layer being laid over the electroconductive substrate,

wherein the surface layer is a crosslinked layer which is cured by irradiating with light energy (hereinafter may be referred to as “light”) a composition containing a radical polymerizable monomer having no charge transporting structure, a radical polymerizable compound having a charge transporting structure and a photopolymerization initiator, and

wherein the radical polymerizable compound having a charge transporting structure has a ratio Ae/As of 0.7 or higher where Ae denotes absorbance at an absorption peak wavelength λ after the radical polymerizable compound having a charge transporting structure is irradiated with light energy and As denotes absorbance at an absorption peak wavelength λ before the radical polymerizable compound having a charge transporting structure is irradiated with light energy.

The radical polymerizable compound having a charge transporting structure has an absorption peak attributed to a charge transporting unit in the wavelength region of 300 nm to 400 nm. When the radical polymerizable compound having a charge transporting structure is irradiated with light having a wavelength of 300 nm to 400 nm among light energy to be irradiated, the charge transporting unit is degraded to lead to a decrease in charge transporting function. Here, the residual rate of the charge transporting unit remaining after irradiation of light energy can be calculated from the ratio of absorbances before and after irradiation of light energy.

When the ratio (Ae/As) of absorbance Ae to absorbance As is 0.7 or higher, it is possible to keep charge transporting capability at a practically usable level. When the ratio (Ae/As) is 0.9 or higher, it is possible to keep charge transporting capability at almost the same level as that before irradiation of light energy.

The charge transporting capability can be kept at a practically usable level by preventing degradation of the charge transporting unit. For preventing degradation of the charge transporting unit, it is necessary to reduce the overlapped region of the absorption wavelength of the radical polymerizable compound having a charge transporting structure with the light emission peak wavelength of light energy, to thereby reduce absorption of light energy by the radical polymerizable compound having a charge transporting structure.

That is, the light emission peak wavelength of light energy to be irradiated is preferably longer than the absorption peak wavelength of the radical polymerizable compound having a charge transporting structure but shorter than the absorption edge wavelength of the photopolymerization initiator, more preferably longer than the absorption edge wavelength of the radical polymerizable compound having a charge transporting structure. Here, the “absorption edge” refers to the edge of a region of a continuous absorption spectrum of light where the absorbance drastically decreases at longer wavelengths than a certain wavelength. The above absorption edge wavelength refers to a wavelength at the above absorption edge. By making the light emission peak wavelength of the light energy irradiated longer than the absorption edge wavelength of the radical polymerizable compound having a charge transporting structure, the charge transporting unit can be prevented from degradation and also a sufficient amount of light energy reaches the photopolymerization initiator present in the inner portion of the surface layer, considerably increasing the crosslinking curing speed.

By making the light emission peak wavelength of the light energy irradiated shorter than the absorption edge wavelength of the photopolymerization initiator, radicals generate more efficiently to thereby initiate rapid crosslinking reaction. When the peak wavelength of the light energy is shorter than the absorption edge wavelength of the radical polymerizable compound having a charge transporting structure, the light energy is absorbed in the radical polymerizable compound having a charge transporting structure and hardly reaches the photopolymerization initiator present in the inner portion of the surface layer, which necessitates extending the irradiation time and elevating the intensity of irradiated light, causing degradation of the charge transporting compound. Also, when the peak wavelength of the light energy is longer than the absorption edge wavelength of the photopolymerization initiator, the photopolymerization initiator generates radicals less efficiently.

The method in which the light energy is irradiated is not particularly limited and may be appropriately selected depending on the intended purpose, but is preferably a method using a LED light source.

The method for forming the crosslinked surface layer is not particularly limited and may be appropriately selected depending on the intended purpose. Examples thereof include a method in which a photoconductive layer is coated with a coating liquid containing the radical polymerizable compound and then irradiated with light energy emitted from, for example, a UV lamp.

In general, the light emitted from the UV lamp contains not only light having a wavelength with which the photopolymerization initiator generates radicals but also infrared light which is a source for generating heat. The light energy of the infrared region increases the temperature of a substrate, resulting in that the surface layer shrinks to form surface irregularities. In addition, the rapid crosslinking reaction results in increased internal stress of the surface layer, more easily causing delamination of the surface layer. The light emitted from the UV lamp has a wide wavelength region. Thus, when this light energy is absorbed by the radical polymerizable compound having a charge transporting structure, the charge transporting unit is degraded to lead to degradation in electrical properties of the formed photoconductor. Even when using a photopolymerization initiator having an absorption edge wavelength longer than the absorption edge wavelength of the radical polymerizable compound having a charge transporting structure and a UV lamp emitting light having longer wavelengths, it is difficult to completely prevent degradation of the radical polymerizable compound having a charge transporting structure.

Although there are filters that cut light having unnecessary wavelengths among light emitted from the UV lamp, such as infrared cut filters and UV cut filters, it is quite difficult to efficiently transmit light having necessary wavelengths without loss of light energy when using a single cut filter. Also, the filter absorbing light having long wavelengths such as the infrared cut filter is elevated in temperature by infrared rays. Thus, the filter does not have satisfactory durability and thus is not applicable to practical use. In general, the UV lamp is driven by an alternating power source and the light emission therefrom becomes periodic to easily cause ununiform crosslinking reaction. Making the UV lamp to emit light requires a large amount of electrical energy. Furthermore, a cooling device such as a blower is required to cool the UV lamp. Therefore, the UV lamp consumes a large amount of electrical energy and limits the installation site due to enlargement of the apparatus.

Unlike common UV lamps, the LED light source is capable of emitting only light of a necessary wavelength region for the photopolymerization initiator to generate radicals. The LED light source can emit light containing neither infrared rays causing generation of heat, nor UV rays degrading the radical polymerizable compound having a charge transporting structure. Also, the LED light source is driven by a direct current source and emits light successively to cause uniform crosslinking reaction in the entire surface layer, not involving an increase in internal stress and surface irregularities. Furthermore, the LED light source is quite small and can be installed at any place, which is preferred.

The peak wavelength of light emitted from the light source is not particularly limited and may be appropriately selected depending on the intended purpose, but is preferably 400 nm or longer. The absorption wavelength region of the radical polymerizable compound having a charge transporting structure is shorter than 400 nm in many cases. Light having a peak wavelength of shorter than 400 nm is absorbed in the radical polymerizable compound having a charge transporting structure. As a result, crosslinking reaction is difficult occur from the inner portion, and also the charge transporting compound is degraded.

The LED light source is not particularly limited and may be appropriately selected depending on the intended purpose. Examples thereof include a light source composed of LED elements having a light emission wavelength in the UV region. Also, the LED light source may be a light source that emits light of the visible region as well as the UV region.

The material for the LED element is not particularly limited and may be appropriately selected depending on the intended purpose. Examples thereof include gallium indium nitride, gallium nitride and gallium aluminum nitride.

The shape of the LED element is not particularly limited and may be appropriately selected depending on the intended purpose. For example, the LED element may be in the form of lamp and may be embedded as a chip in the substrate.

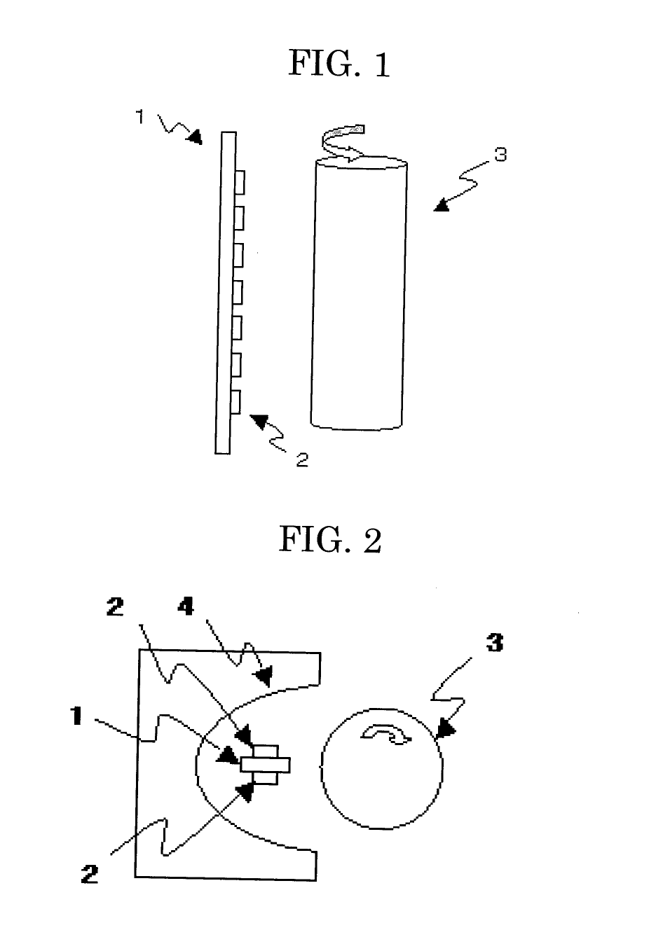

The method for irradiating a photoconductor drum with light energy emitted from the LED light source is not particularly limited and may be appropriately selected depending on the intended purpose. Examples thereof include similar methods to those for conventional UV lamps. Specific examples include: a method as illustrated in FIG. 1 of directly irradiating the photoconductor drum with light energy from the LED light source; and a method as illustrated in FIG. 2 of irradiating the photoconductor drum with light via a reflection plate from the LED light source. Notably, the light energy irradiated from the LED light source does not contain infrared rays causing generation of heat and thus the LED light source does not require cooling the photoconductor drum during irradiation of light energy.

### <Surface Layer>

The surface layer is a crosslinked layer formed by curing through irradiation of light energy a composition (surface layer-coating liquid) containing the radical polymerizable monomer having no charge transporting structure, the radical polymerizable compound having a charge transporting structure, and the photopolymerization initiator.

The surface layer-coating liquid contains at least the radical polymerizable monomer having no charge transporting structure, the radical polymerizable compound having a charge transporting structure, and the photopolymerization initiator; preferably contains an organic solvent; and, if necessary, further contains other components. Notably, the radical polymerizable monomer having no charge transporting structure and the radical polymerizable compound having a charge transporting structure may collectively be referred to as a radical polymerizable compound.

### <<Radical Polymerizable Monomer Having No Charge Transporting Structure>>

The radical polymerizable monomer having no charge transporting structure is not particularly limited and may be appropriately selected depending on the intended purpose, so long as it has a radical polymerizable group such as a carbon-carbon double bond. Examples thereof include monomers having none of hole transporting structures (e.g., triarylamine, hydrazone, pyrrazoline and carbazol) and electron transporting structures (e.g., electron attractive aromatic rings having condensated polycyclic quinone, diphenoquinone, a cyano group and a nitro group).

The radical-polymerizable functional group is not particularly limited and may be appropriately selected depending on the intended purpose. Examples thereof include a 1-substituted ethylene functional group and a 1,1-substituted ethylene functional group.

The 1-substituted ethylene functional group is not particularly limited and may be appropriately selected depending on the intended purpose. Examples thereof include a functional group represented by the following formula.

CH₂═CH—X²—

In this formula, X² represents an arylene group, such as a phenylene group or a naphthylene group, which may have a substituent; an alkenylene group which may have a substituent; a —CO— group; a —COO— group; a —CONR³⁶— group (where R³⁶ represents a hydrogen atom, an alkyl group such as a methyl group or an ethyl group, an aralkyl group such as a benzyl group, a naphthylmethyl group and a phenetyl group, or an aryl group such as a phenyl group or a naphthyl group); or a —S— group.

Examples of the above substituent include a vinyl group, a stylyl group, a 2-methyl-1,3-butadienyl group, a vinylcarbonyl group, an acryloyloxy group, an acryloylamide group and a vinylthioether group.

The 1,1-substituted ethylene functional group is not particularly limited and may be appropriately selected depending on the intended purpose. Examples thereof include a functional group represented by the following formula.

CH₂═C(Y⁴)—X³—

In this formula, Y⁴ represents an alkyl group which may have a substituent; an aralkyl group which may have a substituent; an aryl group such as a phenyl group or a naphthyl group which may have a substituent; a halogen atom; a cyano group; a nitro group; an alkoxy group such as a methoxy group or an ethoxy group; a —COOR³⁷ group (where R³⁷ represents a hydrogen atom; an alkyl group such as a methyl group or an ethyl group which may have a substituent; an aralkyl group such as a benzyl group or a phenetyl group which may have a substituent; an aryl group such as a phenyl group or a naphthyl group which may have a substituent; or a —CONR³⁸R³⁹ group (where R³⁸ and R³⁹ each represent a hydrogen atom; an alkyl group such as a methyl group or an ethyl group which may have a substituent; an aralkyl group such as a benzyl group, a naphthylmethyl group or a phenetyl group which may have a substituent; an aryl group such as a phenyl group or a naphthyl group which may have a substituent)) and X³ represents the same group as the above-defined X², a single bond or an alkylene group, with the proviso that at least one of Y⁴ and X³ represents an oxycarbonyl group, a cyano group, an alkenylene group and an aromatic ring.

The above substituent is not particularly limited and may be appropriately selected depending on the intended purpose. Examples thereof include α-chloroacrylolyoxy group, a methacrylolyoxy group, an α-cyanoethylene group, an α-cyanoacryloyloxy group, an α-cyanophenylene group and a methacryloylamino group.

The substituent the group represented by X², X³ or Y⁴ may further have is not particularly limited and may be appropriately selected depending on the intended purpose. Examples thereof include: a halogen atom; a nitro group; a cyano group; an alkyl group such as a methyl group or an ethyl group; an alkoxy group such as a methoxy group and an ethoxy group; an aryloxy group such as a phenoxy group; an aryl group such as a phenyl group and a naphthyl group; and an aralkyl group such as a benzyl group and a phenetyl group, with an acryloyloxy group and a methacryloyloxy group being preferred.

The number of functional groups of the radical polymerizable monomer having no charge transporting structure is not particularly limited and may be appropriately selected depending on the intended purpose.

Among the radical polymerizable monomer having no charge transporting structure, the amount of a monofunctional (one functional group-containing) or difunctional (two functional groups-containing) radical polymerizable monomer or oligomer is not particularly limited and may be appropriately selected depending on the intended purpose. It is preferably 50 parts by mass or less, 30 parts by mass or less, per 100 parts by mass of the tri- or higher-functional radical polymerizable monomer. Incorporation of the monofunctional or difunctional radical polymerizable monomer or oligomer in a large amount substantially reduces the three-dimensional crosslink density of the formed surface layer, leading to degradation in abrasion resistance.

The radical polymerizable monomer having no charge transporting structure is not particularly limited and may be appropriately selected depending on the intended purpose. Examples thereof include stearyl acrylate, tetrahydrofurfuryl acrylate, lauryl acrylate, 2-phenoxy acrylate, tridecyl acrylate, caprolactone acrylate, EO-modified nonylphenyl acrylate, isobornyl acrylate, tetrahydrofurfuryl methacrylate, lauryl methacrylate, stearyl methacrylate, 2-phenoxyethyl methacrylate, isobornyl methacrylate, PO-modified allyl methacrylate, EO-modified hydroxyethyl methacrylate, 1,3-butyleneglycol diacrylate, 1,4-butanediol diacrylate, diethyleneglycol diacrylate, 1,6-hexanediol diacrylate, neopentylglycol diacrylate, tetraethyleneglycol diacrylate, triethyleneglycol diacrylate, tripropyleneglycol diacrylate, EO-modified bisphenol A diacrylate, cyclohexanedimethanol diacrylate, dipropyleneglycol diacrylate, PO-modified neopentylglcol diacrylate, EO-modified bisphenol A dimethacrylate, triethyleneglycol dimethacrylate, ethyleneglycol dimethacrylate, tetraethyleneglycol dimethacrylate, polyethyleneglycol dimethacrylate, 1,4-butanediol dimethacrylate, diethyleneglycol dimethacrylate, 1,6-hexanediol dimethacrylate, neopentylglycol dimethacrylate, 1,3-butyleneglycol dimethacrylate, cyclohexanedimethanol dimethacrylate, trimethylolpropane triacrylate (TMPTA), trimethylolpropane trimethacrylate, HPA-modified trimethylolpropane triacrylate, EO-modified trimethylolpropane triacrylate, PO-modified trimethylolpropane triacrylate, caprolactone-modified trimethylolpropane triacrylate, HPA-modified trimethylolpropane trimethacrylate, pentaerythritol triacrylate, pentaerythritol tetraacrylate (PETTA), glycerol triacrylate, ECH-modified glycerol triacrylate, EU-modified glycerol triacrylate, PO-modified glycerol triacrylate, tris(acryloxyethyl) isocyanulate, dipentaerythritol hexaacrylate (DPHA), caprolactone-modified dipentaerythritol hexaacrylate, dipentaerythritol hydroxyl pentaacrylate, alkyl-modified dipentaerythritol pentaacrylates, alkyl-modified dipentaerythritol tetraacrylates, alkyl-modified dipentaerythritol triacrylates, dimethylolpropane tetraacrylate (DTMPTA), pentaerythritol ethoxyteteraacrylate, EO-modified phosphoric acid triacrylate and 2,2,5,5-tetrahydroxymethylcyclopentanone tetraacrylate. These may be used alone or in combination.

### <<Radical Polymerizable Compound Having a Charge Transporting Structure>>

The radical polymerizable compound having a charge transporting structure is not particularly limited and may be appropriately selected depending on the intended purpose. Examples thereof include: compounds having a hole transporting structure (e.g., triarylamine, hydrazone, pyrrazoline or carbazol) or an electron transporting structure (e.g., an electron attractive aromatic ring having condensated polycyclic quinone, diphenoquinone, a cyano group or a nitro group) and also having a radical polymerizable functional group, with radical polymerizable compounds having a triarylamine structure being preferred.

The radical polymerizable functional group is not particularly limited and may be appropriately selected depending on the intended purpose. Examples thereof include those listed above for the radical polymerizable monomer, with an acryloyloxy group and a methacryloyloxy group being preferred.

The number of functional groups of the radical polymerizable compound having a charge transporting structure is not particularly limited and may be appropriately selected depending on the intended purpose. The radical polymerizable compound having a charge transporting structure has, for example, a plurality of functional groups (i.e., multifunctional or di- or higher-functional) or one functional group (i.e., monofunctional), preferably monofunctional.

When the number of functional groups of the radical polymerizable compound having a charge transporting structure is two or more; i.e., the radical polymerizable compound having a charge transporting structure is di- or higher-functional, the charge transporting structure thereof is quite bulky. When the charge transporting structure is fixed in the crosslinked structure via a plurality of bonds, the cured resin is strained to thereby increase the internal stress of the surface layer, resulting in that cracks and scratches are easily formed due to carrier deposition. Especially when the surface layer formed has a thickness of greater than 5 μm, the internal stress of the surface layer becomes quite high and cracks are easier to be formed immediately after crosslinking. Since the bi- or higher-functional charge transporting compound is fixed in the crosslinked structure via a plurality of bonds, an intermediate structure (cation radical) during charge transportation cannot be stably maintained and the lowering of the sensitivity and the elevation of the residual potential due to trap of charges are easily caused. These impairements of the electrical properties cause the lowering of the image density and the image having a thinned letter. For this reason, the radical polymerizable compound having a charge transporting structure is preferably a monofunctional radical polymerizable compound having a charge transporting structure fixed among crosslinked points in the form of a pendant, since cracks and scratches can be prevented from being formed and electrostatic properties can be stabilized.

The monofunctional radical polymerizable compound having a charge transporting structure is not particularly limited and may be appropriately selected depending on the intended purpose. Preferred are compounds represented by the following General Formulas (1) and (2) since they makes it possible to continuously obtain good electrical properties such as charge transporting sensitivity and residual potential.

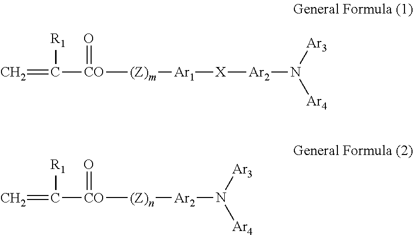

In General Formulas (1) and (2), R¹ represents a group selected from a hydrogen atom, a halogen atom, an alkyl group which may have a substituent, an aralkyl group which may have a substituent, an aryl group which may have a substituent, a cyano group, a nitro group, an alkoxy group, a —COOR⁷ group (where R⁷ represents a hydrogen atom, an alkyl group which may have a substituent, an aralkyl group which may have a substituent and an aryl group which may have a substituent), a halogenated carbonyl group and —CONR⁸R⁹ (where R⁸ and R⁹, which may be identical or different, each represent a group selected from a hydrogen atom, a halogen atom, an alkyl group which may have a substituent, an aralkyl group which may have a substituent and an aryl group which may have a substituent); Ar¹ and Ar² each represent an unsubstituted or substituted arylene group and may be identical or different; Ar³ and Ar⁴ each represent a group selected from an unsubstituted or substituted aryl group and may be identical or different; X represents a single bond, an unsubstituted or substituted alkylene group, an unsubstituted or substituted cycloalkylene group, an unsubstituted or substituted alkylene ether group, an oxygen atom, a sulfur atom and a vinylene group; Z represents a group selected from an unsubstituted or substituted alkylene group, an unsubstituted or substituted alkylene ether group and an alkyleneoxycarbonyl group; and m and n each are an integer of 0 to 3.

Specific examples of General Formulas (1) and (2) will be given below.

In General Formulas (1) and (2), when R¹ is the alkyl group, examples of the alkyl group include a methyl group, an ethyl group, a propyl group and a butyl group; when R¹ is the aryl group, examples thereof include a phenyl group and a naphthyl group; when R¹ is the aralkyl group, examples thereof include a benzyl group, a phenetyl group and a naphthylmethyl group; and when R¹ is the alkoxy group, examples thereof include a methoxy group, an ethoxy group and a propoxy group. These groups may also have a substituent such as a halogen atom, a nitro group, a cyano group, an alkyl group (e.g., a methyl group or an ethyl group), an alkoxy group (e.g., a methoxy group or an ethoxy group), an aryloxy group (e.g., a phenoxy group), an aryl group (e.g., a phenyl group or a naphthyl group) and an aralkyl group (e.g., a benzyl group or a phenetyl group). Among them, a hydrogen atom and a methyl group are preferred.

Examples of the group represented by Ar³or Ar⁴ include a condensated polycyclic hydrocarbon group, a non-condensed cyclic hydrocarbon group and a heterocyclic group.

The condensated polycyclic hydrocarbon group is not particularly limited and may be appropriately selected depending on the intended purpose. Preferred are condensated polycyclic hydrocarbon groups the ring of which has 18 or less carbon atoms. Specific examples thereof include a pentanyl group, an indenyl group, a naphthyl group, an azulenyl group, a heptanyl group, a biphenylenyl group, an as-indacenyl group, a s-indacenyl group, a fluorenyl group, an acenaphthylenyl group, a pleiadenyl group, an acenaphthenyl group, a phenalenyl group, a phenanthryl group, an anthryl group, a fluoranthenyl group, an acephenanthrylenyl group, an aceantrylenyl group, a triphenylenyl group, a pyrrenyl group, a chrysenyl group and a naphthacenyl group.

The non-condensed cyclic hydrocarbon group is not particularly limited and may be appropriately selected depending on the intended purpose. Examples thereof include: monovalent groups of monocyclic hydrocarbon compounds, such as benzene, diphenyl ether, polyethylene dipheny ether, diphenylthio ether and diphenyl sulfon; monovalent groups of non-condensed polycyclic hydrocarbon compounds, such as biphenyl, polyphenyl, diphenylalkane, diphenylalkene, diphenylalkyne, triphenylmethane, distyrylbenzene, 1,1-diphenylcycloalkane, polyphenylalkane and polyphenylalkene; and monovalent groups of collected-cyclic hydrocarbon compounds, such as 9,9-diphenylfluorene.

The heterocyclic group is not particularly limited and may be appropriately selected depending on the intended purpose. Examples thereof include monovalent groups of carbazol, dibenzofuran, dibenzothiophene, oxyadiazole and thiadiazole.

The aryl group represented by Ar³or Ar⁴ is not particularly limited and may be appropriately selected depending on the intended purpose. Examples thereof include aryl groups having the following substituents (1) to (8):

(1) a halogen atom, a cyano group and a nitro group;
(2) an alkyl group (the number of carbon atoms contained in the alkyl group is not particularly limited and may be appropriately selected depending on the intended purpose, but is preferably C₁ to C₁₂, more preferably C₁ to C₈, particularly preferably C₁ to C₄. The alkyl group may be linear or branched, and may have a fluorine atom, a hydroxyl group, a cyano group, a C₁ to C₄ alkoxy group, a phenyl group and/or a phenyl group having as a substituent a halogen atom, a C₁ to C₄ alkyl group or a C₁ to C₄ alkoxy group. Specific examples of the alkyl group include a methyl group, an ethyl group, a n-butyl group, an i-propyl group, a t-butyl group, a s-butyl group, a n-propyl group, a trifluoromethyl group, a 2-hydroxyethyl group, a 2-ethoxyethyl group, a 2-cyanoethyl group, a 2-methoxyethyl group, a benzyl group, a 4-chlorobenzyl group, a 4-methylbenzyl group and a 4-phenylbenzyl group;
(3) an alkoxy group (—OR²) (R² represents the alkyl group defined in the above (2)). Examples of the alkoxy group include a methoxy group, an ethoxy group, a n-propoxy group, an i-propoxy group, a t-butoxy group, a n-butoxy group, a s-butoxy group, an i-butoxy group, a 2-hydroxyethoxy group, a benzyloxy group and a trifluoromethoxy group);
(4) an aryloxy group (examples of the aryloxy group include a phenyl group and a naphthyl group. The aryloxy group may have as a substituent a C₁ to C₄ alkoxy group, a C₁ to C₄ alkyl group and a halogen atom. Specific examples of the aryloxy group having such a substituent include a phenoxy group, a 1-naphthyloxy group, a 2-naphthyloxy group, a 4-methoxyphenoxy group and a 4-methylphenoxy group);
(5) an alkylmercapto group and an arylmercapto group (examples of the specific examples thereof include a methylthio group, an ethylthio group, a phenylthio group and a p-methylphenylthio group;
(6) a group represented by the following formula:

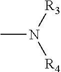

where R³ and R⁴ represent each independently a hydrogen atom, the alkyl group defined in (2) above, and an aryl group (examples of the aryl group include a phenyl group, a biphenyl group and a naphthyl group, each of which may have as a substituent a C₁ to C₄ alkoxy group, a C₁ to C₄ alkyl group or a halogen atom. R³ and R⁴ may form a ring together. Examples of the group represented by this formula include an amino group, a diethylamino group, a N-methyl-N-phenyl amino group, a N,N-diphenylamino group, a N,N-di(tolyl)amino group, a dibenzylamino group, a piperidino group, a morpholino group and a pyrrolidino group;

(7) an alkylenedioxy group and an alkylenedithio group (examples of the alkylenedioxy group include a methylenedioxy group and examples of the alkylenedithio group include a methylenedithio group); and
(8) an unsubstituted or substituted styryl group, an unsubstituted or substituted β-phenylstyryl group, a diphenylaminophenyl group and a ditolylaminophenyl group.

The arylene group represented by Ar¹or Ar² is, for example, a divalent group derived from the aryl group represented by Ar³or Ar⁴.

The above X represents a single bond, an unsubstituted or substituted alkylene group, an unsubstituted or substituted cycloalkylene group, an unsubstituted or substituted alkylene ether group, an oxygen atom, a sulfur atom and a vinylene group.

The number of the unsubstituted or substituted alkylene group is not particularly limited and may be appropriately selected depending on the intended purpose, but is preferably C₁ to C₁₂, more preferably C₁ to C₈, particularly preferably C₁ to C₄.

The unsubstituted or substituted alkylene group may be linear or branched. The alkylene group may have a fluorine atom, a hydroxyl group, a cyano group, a C₁ to C₄ alkoxy group, a phenyl group and a phenyl group having as a substituent a halogen atom, a C₁ to C₄ alkyl group or a C₁ to C₄ alkoxy group. Specific examples of the alkylene group include a methylene group, an ethylene group, a n-butylene group, an i-propylene group, a t-butylene group, a s-butylene group, a n-propylene group, a trifluoromethylene group, a 2-hydroxyethylene group, a 2-ethoxyethylene group, a 2-cyanoethylene group, a 2-methoxyethylene group, a benzylidene group, a phenylethylene group, a 4-chlorophenylethylene group, a 4-methylphenylethylene group and a 4-biphenylethylene group.

Examples of the unsubstituted or substituted cycloalkylene group include C₅ to C₇ cyclicalkylene groups. The cyclicalkylene group may have a fluorine atom, a hydroxyl group, a C₁ to C₄ alkyl group and a C₁ to C₄ alkoxy group. Specific examples of the unsubstituted or substituted cycloalkylene group include a cyclohexylidene group, a cyclohexylene group and 3,3-dimethylcyclohexylidene group.

Examples of the above unsubstituted or substituted alkylene ether group include an ethyleneoxy group, a propyleneoxy group, an ethyleneglycol group, a propyleneglycol group, a diethyleneglycol group, a tetraethyleneglycol group and a tripropyleneglycol group. The alkylene group or the alkylene ether group may have a substituent such as a hydroxyl group, a methyl group and an ethyl group.

The above vinylene group is represented by the following formula:

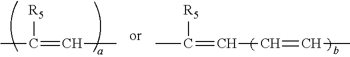

In the above formulas, R⁵ represents a hydrogen atom, an alkyl group (which is the same as the alkyl group defined in the above (2)) and an aryl group (which is the same as the aryl group defined for Ar³or Ar⁴) and a is an integer of 1 or 2 and b is an integer of 1 to 3.

The above Z represents an unsubstituted or substituted alkylene group (which is the same as the alkylene group defined for the above X), an unsubstituted or substituted alkylene ether group (which is the same as the alkylene ether group defined for the above X) or an unsubstituted or substituted alkyleneoxycarbonyl group (e.g., a caprolactone-modified group).

The monofunctional radical polymerizable compound having a charge transporting structure is not particularly limited and may be appropriately selected depending on the intended purpose, but is preferably a compound represented by the following General Formula (3):

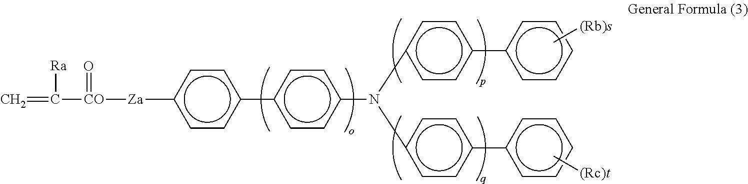

In General formula (3), R^{a} represents a hydrogen atom or a methyl group, R^{b} and R^{c} may be the same or different and each represent a C₁ to C₆ alkyl group (i.e., a substituent other than a hydrogen atom) (the alkyl group is preferably a methyl group or an ethyl group), o, p and q are each an integer of 0 or 1, s and t are each an integer of 0 to 3, Z^{a} represents a single bond, a methylene group, an ethylene group and the following group:

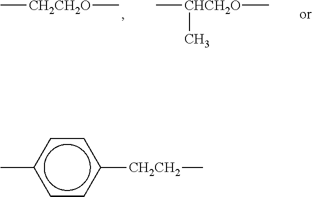

When the compound represented by General Formula (1), (2) or (3) (especially, the compound represented by General Formula (3)) which is the monofunctional radical polymerizable compound having a charge transporting structure is polymerized, the C═C double bond thereof is opened at the both sides. Thus, the above compound does not become a terminal structure but is incorporated into a chain polymer. In the cured resin obtained through copolymerization between the above compound and a radical polymerizable monomer, the above compound exists in the backbone thereof and exists in the crosslinked chain between one backbone and another backbone. Notably, the above crosslinked chain has two types; i.e., the intermolecular crosslinked chain between one polymer and another polymer and the intramolecular crosslinked chain which crosslinks a site with another site of the folded backbone in one polymer. Whether the above compound exists in the above backbone or in the above crosslinked chain, the triarylamine structure pending from the chain has at least three aryl groups arranged in the radiation direction from the nitrogen atom and is bulky. However, since the triarylamine structure is bonded to the chain not directly but through the carbonyl group and is accordingly fixed in a three-dimensionally flexible state, the triarylamine structure can be arranged in the cured resin in such a manner that the triarylamine structure adjoins properly to another structure and as a result the structural strain in the polymer containing the triarylamine structure is small. Therefore, it is assumed that when the triarylamine structure is incorporated into the surface layer, the triarylamine structure can take an intramolecular structure which is relatively free from the extinction of the charge transporting path.

When the absorption wavelength of the photopolymerization initiator is overlapped with that of the radical polymerizable compound having a charge transporting structure, the light energy is absorbed in the radical polymerizable compound having a charge transporting structure. The light energy hardly reaches the photopolymerization initiator, which drastically reduce the crosslinking speed. Thus, the absorption edge wavelength of the radical polymerizable compound having a charge transporting structure has to be shorter than the absorption edge wavelength of the photopolymerization initiator. When the absorption edge wavelength of the radical polymerizable compound having a charge transporting structure is shorter than the peak wavelength of light emitted from a light source, it is possible to suppress degradation in electrical properties which would otherwise be caused as a result of decomposition of the radical polymerizable compound having a charge transporting structure. In addition, since the amount of the light energy absorbed by the radical polymerizable compound having a charge transporting structure becomes quite small, the copolymerization reaction uniformly occurs between the radical polymerizable compound having a charge transporting structure and the radical polymerizable monomer. As a result, in the polymerization reaction for forming the surface layer (film), the internal stress in the film does not occur and the crosslinking density becomes uniform, which is preferred.

The radical polymerizable compound having a charge transporting structure is a compound that imparts charge transporting properties to the surface layer.

The amount of the radical polymerizable compound having a charge transporting structure contained in the surface layer is not particularly limited and may be appropriately selected depending on the intended purpose, but is preferably 20% by mass to 80% by mass, more preferably 30% by mass to 70% by mass. When the amount thereof is less than 20% by mass, the formed surface layer cannot satisfactorily maintain its charge transporting properties, so that after repetitive use, there may be degradation of electric properties such as the lowering of the sensitivity and the elevation of the residual potential. Whereas when the amount thereof is more than 80% by mass, the amount of the radical polymerizable monomer having no charge transporting structure becomes small, so that the crosslinking density is lowered and the surface layer cannot exhibit high abrasion resistance in some cases. It is advantageous that the amount of the radical polymerizable compound having a charge transporting structure falls within the above preferred range from the viewpoint of striking a favorable balance between electrical properties and abrasion resistance, although these vary in required levels depending on the process employed and accordingly cannot flatly determined.

### <<Photopolymerization Initiator>>

The photopolymerization initiator is an initiator used for radical polymerizing through light energy the radical polymerizable compound contained in the surface layer-coating liquid.

Examples of the photopolymerization initiator include acetophenone or ketal photopolymerization initiators such as diethoxyacetophenone, 2,2-dimethoxy-1,2-diphenylethan-1-one, 1-hydroxy-cyclohexyl-phenyl-ketone, 4-(2-hydroxyethoxy)phenyl-(2-hydroxy-2-propyl)ketone, 2-benzyl-2-dimethylamino-1-(4-morpholinophenyl)butanone-1,2-hydroxy-2-methyl-1-phenylpropan-1-one, 2-methyl-2-morpholino(4-methylthiophenyl)propan-1-one and 1-phenyl-1,2-propanedione-2-(o-ethoxycarbonyl)oxime; benoin ether photopolymerization initiators such as benzoine, benzoine methyl ether, benzoin ethyl ether, benzoin isobutyl ether and benzoin isopropyl ether; benzophenone photopolymerization initiators such as benzophenone, 4-hydroxybenzophenone, methyl o-benzoylbenzoate, 2-benzoylnaphthalene, 4-benzoylbiphenyl, 4-benzoyl phenyl ether, acrylated benzophenone and 1,4-benzoylbenzene; thioxantone photopolymerization initiators such as 2-isopropylthioxantone, 2-chlorothioxantone, 2,4-dimethylthioxantone, 2,4-diethylthioxantone and 2,4-dichlorothioxantone; phosphine oxide compounds such as ethylanthraquinone, 2,4,6-trimethylbenzoyldiphenylphosphine oxide, 2,4,6-trimethylbenzoylphenylethoxyphosphine oxide, bis(2,4,6-trimethylbenzoyl)phenylphosphine oxide and his (2,4-dimethoxybenzoyl)-2,4,4-trimethylpentylphosphine oxide; and other photopolymerization initiators such as methylphenylglyoxy ester, 9,10-phenanthrene, acridine compounds, triazine compounds and imidazol compounds. These may be used alone or in combination. Among them, acylphosphineoxide compounds are preferred.

The acylphosphineoxide compound absorbs light of the visible region having a wavelength of 400 nm or higher and efficiently absorbs light having transmitted the radical polymerizable compound having a charge transporting structure to generate radicals. The acylphosphineoxide compound has a photo-bleaching effect, in which a compound does not absorb light after decomposed, and thus is excellent in curing property inside the film. Therefore, there are less adverse effects caused by unevenness in light irradiation in the planar direction and by unevenness in light transmission inside the film, and uniform curing reaction instantly proceeds in the direction of the film surface and the direction of the film thickness. As a result, there are not formed irregularities which would otherwise be formed due to the differences of volume shrinkage and hardness between the cured portion and the uncured portion, and a high smooth crosslinked film can be obtained.

A photopolymerization accelerator may be used in combination with the photopolymerization initiator.

The photopolymerization accelerator is not particularly limited and may be appropriately selected depending on the intended purpose.

Examples of the photopolymerization accelerator include triethanolamine, methyldiethanolamine, ethyl 4-dimethylaminobenzoate, isoamyl 4-dimethylaminobenzoate, (2-dimethylamino)ethyl benzoate and 4,4′-dimethylaminobenzophenone.

### <<Organic Solvent>>

The organic solvent is preferably contained in the surface layer-coating liquid. The surface layer is formed by coating the coating liquid containing at least the radical polymerizable compound, followed by curing. When the radical polymerizable compound contained in the coating liquid is liquid, the radical polymerizable compound is capable of dissolving other components. If necessary, the coating liquid may be diluted with the organic solvent before coating.

The organic solvent is not particularly limited and may be appropriately selected depending on the intended purpose. Example thereof include: alcohol organic solvents such as methanol, ethanol, propanol and butanol; ketone organic solvents such as acetone, methyl ethyl ketone, methyl isobutyl ketone and cyclohexanone; ester organic solvents such as ethyl acetate and butyl acetate; ether solvents such as tetrahydrofuran, dioxane and propyl ethers; halogenated organic solvents such as dichloromethane, dichloroethane, trichloroethane and chlorobenzene; aromatic organic solvent such as benzene, toluene and xylene; and cellosolve (registered trademark) organic solvent such as methyl cellosolve, ethyl cellosolve and cellosolve acetate. These may be used alone or in combination.

The degree of the dilution by the organic solvent is not particularly limited and may be appropriately selected depending on the solubility of the coating liquid, the coating method and the intended thickness of the surface layer.

The coating method for the coating liquid is not particularly limited and may be appropriately selected depending on the intended purpose. Examples thereof include dip coating, spray coating, bead coating and ring coating.

### <<Other Components>>

The other components are not particularly limited and may be appropriately selected depending on the intended purpose, so long as they cannot impede the effects of the present invention. Examples thereof include known additives such as a plasticizer (which is added for reducing stress and improving adhesiveness), a leveling agent, and a low-molecular-weight charge transporting compound having no radical reactivity.

### —Plasticizer—

The plasticizer is not particularly limited and may be appropriately selected depending on the intended purpose. Examples of the plasticizer include common plasticizers used for resins, such as dibutyl phthalate and dioctyl phthalate.

The amount of the plasticizer is not particularly limited and may be appropriately selected depending on the intended purpose. It is preferably 20% by mass or less, 10% by mass or less, relative to the total solid content of the surface layer-coating liquid.

### —Leveling Agent—

The leveling agent is not particularly limited and may be appropriately selected depending on the intended purpose. Examples of the leveling agent include: silicone oils such as dimethylsilicone oil and methylphenylsilicone oil; and polymers or oligomers having a perfluoroalkyl group in the side chain thereof.

The amount of the leveling agent is not particularly limited and may be appropriately selected depending on the intended purpose. It is preferably 3% by mass or less relative to the total solid content of the surface layer-coating liquid.

### <<Method for Forming the Surface Layer>>

The method for forming the surface layer is not particularly limited and may be appropriately selected depending on the intended purpose. In one exemplary method, an electrophotographic photoconductor where an under layer, a charge generation layer and the above charge transport layer are sequentially laminated on a substrate such as an aluminum cylinder is coated through spraying with the above surface layer-coating liquid, following by drying for a short time at a relatively low temperature (20° C. to 80° C., 1 min to 10 min) and being irradiated with light energy for curing.

The method for preparing the surface layer-coating liquid will specifically be described.

When the surface layer-coating liquid is prepared using an acrylate monomer having three acryloyloxyl groups and a triarylamine compound having one acryloyloxyl group, the ratio between the amount of the acrylate monomer and the amount of the triarylamine compound (acrylate monomer triarylamine compound) is not particularly limited and may be appropriately selected depending on the intended purpose, but is preferably 7:3 to 3:7.

The amount of the polymerization initiator contained in the surface layer-coating liquid is not particularly limited and may be appropriately selected depending on the intended purpose, but is preferably 3% by mass to 20% by mass relative to the total amount of the above-described acrylate compound.

In addition, the organic solvent may be added to the surface layer-coating liquid.

The organic solvent is not particularly limited and may be appropriately selected depending on the intended purpose. When a triarylamine donor is used as the charge transporting compound of the charge transporting layer underlying the surface layer, polycarbonate is used as a binder resin, and the surface layer is formed through spray coating, tetrahydrofuran, 2-butanone or ethyl acetate is preferably used.

The amount of the organic solvent added is not particularly limited and may be appropriately selected depending on the intended purpose. It is three to ten times the total amount of the above acrylate compound.

The irradiation of the light energy may be performed with a LED.

The irradiation dose of light emitted from the LED is not particularly limited and may be appropriately selected depending on the intended purpose, but is preferably 50 mW/cm² or more but less than 3,000 mW/cm², more preferably 200 mW/cm² or more but less than 1,500 mW/cm². When the irradiation dose is less than 50 mW/cm², it takes a lot of time to complete the curing reaction. Whereas when the irradiation dose is 3,000 mW/cm² or more, the crosslinking reaction ununiformly proceeds since the light emitted from the LED has a narrow wavelength region. As a result, the surface layer becomes more irregular and electrical properties are degraded considerably.

When the surface layer is cured with light energy, it is necessary to prevent oxygen from inhibiting the crosslinking reaction. The oxygen concentration when curing the surface layer is not particularly limited and may be appropriately selected depending on the intended purpose, but is preferably 0.001% by mass to 2.0% by mass. When the oxygen concentration falls within the above preferred range, light energy can be applied while maintaining an atmosphere having a low oxygen concentration, which is advantageous in that it is possible to form a film having a high crosslinking density and high surface smoothness. In addition, it is possible to form a relatively good film even with low irradiation dose of light. Also, since the atmosphere contains oxygen in an amount of about 21%, it is preferable to replace the air in the light energy irradiation vessel by feeding thereto inert gas such as nitrogen, helium or argon.

After completion of curing the surface layer-coating liquid, the cured product is preferably heated to remove the residual solvent and the residual initiator and also stabilize the surface film, whereby an electrophotographic photoconductor is obtained.

The heating temperature is not particularly limited and may be appropriately selected depending on the intended purpose, but is preferably 100° C. to 150° C.

The heating time is not particularly limited and may be appropriately selected depending on the intended purpose, but is preferably 10 min to 30 min.

The thickness of the surface layer is not particularly limited and may be appropriately selected depending on the intended purpose, but is preferably 1 μm to 20 μm, more preferably 2 μm to 10 μm. When the thickness thereof is smaller than 1 μm, the obtained durability may be varied due to unevenness in film thickness. Whereas when the thickness thereof is greater than 20 μm, the thickness of the entire charge transport layer becomes greater, resulting in that image reproducibility may be degraded as a result of diffusion of charges.

### [Layer Structure of Electrophotographic Photoconductor]

The layer structure of an electrophotographic photoconductor of the present invention will next be described with reference to the drawings.

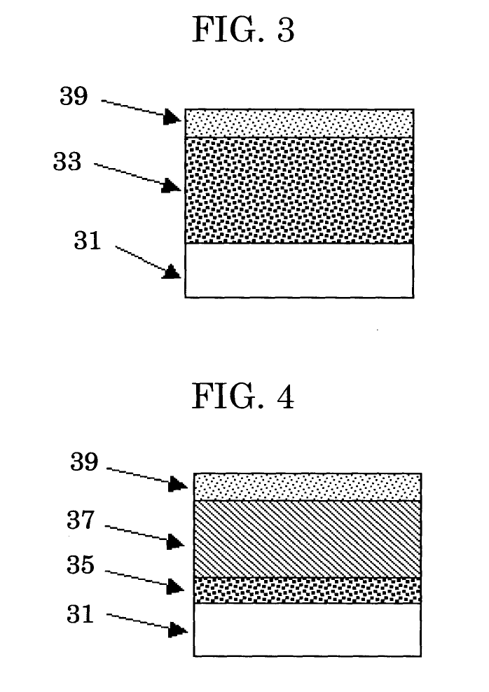

FIG. 3 is a cross-sectional view of an electrophotographic photoconductor of the present invention including: an electroconductive substrate (31); a single-layered photoconductive layer (33) having both a charge-generating function and a charge-transporting function; and a crosslinked surface layer (39), where the single-layered photoconductive layer (33) is formed on the electroconductive substrate (31) and the crosslinked surface layer (39) is formed on the single-layered photoconductive layer (33).

FIG. 4 is a cross-sectional view of another electrophotographic photoconductor including: an electroconductive substrate (31); a laminated photoconductive layer where a charge transport layer (37) having a charge-transporting function is laminated on a charge generation layer (35) having a charge-generating function; and a crosslinked surface layer (39), where the laminated photoconductive layer is formed on the electroconductive substrate (31) and the crosslinked surface layer (39) is formed on the laminated photoconductive layer.

### <Electroconductive Substrate>

The electroconductive substrate is not particularly limited, so long as it has a volume resistivity of 10¹⁰ Ω·cm or less, and may be appropriately selected depending on the intended purpose.

The method for forming the electroconductive substrate is not particularly limited and may be appropriately selected depending on the intended purpose. Examples thereof include: a method in which a substrate (e.g., film-form or cylindrical plastic or paper) is coated with a metal (e.g, aluminum, nickel, chromium, nichrome, copper, gold, silver or platinum) or a metal oxide (e.g., tin oxide or indium oxide) through vapor deposition or sputtering; and a method in which a plate of metal (e.g., aluminum, an aluminum alloy, nickel or stainless steel) is extruded or pultruded into a raw tube, which is then subjected to surface treatments (e.g., cutting, superfinishing and polishing).

The electroconductive substrate is not particularly limited and may be appropriately selected depending on the intended purpose. Examples thereof include an endless nickel belt and an endless stainless-steel belt described in JP-A No. 52-36016. The electroconductive substrate is preferably one formed by providing an appropriate cylindrical support with, as an electroconductive layer, a heat-shrinkable tube containing the above electroconductive powder and a material such as polyvinyl chloride, polypropylene, polyester, polystyrene, polyvinylidene chloride, polyethylene, chlorinated rubber or TEFLON.

The electroconductive layer can be formed through coating of a binder resin containing electroconductive powder dispersed therein.

The electroconductive powder is not particularly limited and may be appropriately selected depending on the intended purpose. Examples thereof include carbon black, acethylene black; powder of a metal such as aluminum, nickel, iron, nichrome, copper, zinc or silver; and powder of a metal oxide such as electroconductive tin oxide or ITO.

The binder resin is not particularly limited and may be appropriately selected depending on the intended purpose. Examples thereof include thermoplastic resins, thermosetting resins and photocurable resins such as polystyrenes, styrene-acrylonitrile copolymers, styrene-butadiene copolymers, styrene-maleic anhydride copolymers, polyesters, polyvinyl chlorides, vinyl chloride-vinyl acetate copolymers, polyvinyl acetates, polyvinylidene chlorides, polyarylate resins, phenoxy resins, polycarbonates, cellulose acetate resins, ethyl cellulose resins, polyvinyl butyrals, polyvinyl formals, polyvinyl toluenes, poly-N-vinylcarbazoles, acrylic resins, silicone resins, epoxy resins, melamine resins, urethane resins, phenol resins and alkyd resins.

The electroconductive layer may be formed through coating of a dispersion liquid where the electroconductive powder and the binder resin are dispersed in an appropriate solvent (e.g., tetrahydrofuran, dichloromethane, methyl ethyl ketone or toluene).

### <Photoconductive Layer>

The photoconductive layer has a laminated structure or a single-layered structure.

When the photoconductive layer has a laminated structure, the photoconductive layer is composed of a charge generation layer having a charge-generating function and a charge transport layer having a charge-transporting function.

When the photoconductive layer has a single-layered structure, the photoconductive layer is a layer having both a charge-generating function and a charge-transporting function.

Next will be described the laminated photoconductive layer and the single-layered photoconductive layer.

### <<Laminated Photoconductive Layer>>

### —Charge Generation Layer—

The charge generation layer is a layer mainly containing a charge generating compound having a charge generating function.

The charge generation layer may optionally contain a binder resin in combination.

The charge generating compound is not particularly limited and may be appropriately selected depending on the intended purpose. Examples thereof include inorganic materials and organic materials. These may be used alone or in combination.

The inorganic material is not particularly limited and may be appropriately selected depending on the intended purpose. Examples thereof include crystalline selenium, amorphous selenium, selenium-tellurium, selenium-tellurium-halogen, a selenium-arsenic compound and amorphous silicon (preferably, amorphous silicon in which the dangling bonds are terminated with hydrogen atoms or halogen atoms or amorphous silicon which is doped with a boron atom or a phosphorus atom).

The organic material is not particularly limited and may be appropriately selected depending on the intended purpose. Examples thereof include phthalocyanine pigments such as metal phthalocyanines and metal-free phthalocyanines; azulenium salt pigments, methine squarate pigments, azo pigments having a carbazole skeleton, azo pigments having a triphenylamine skeleton, azo pigments having a diphenylamine skeleton, azo pigments having a dibenzothiophene skeleton, azo pigments having a fluorenone skeleton, azo pigments having an oxadiazole skeleton, azo pigments having a bis-stilbene skeleton, azo pigments having a distilyloxadiazole skeleton, azo pigments having a distilylcarbazole skeleton, perylene pigments, anthraquinone and multicyclic quinone pigments, quinoneimine pigments, diphenylmethane and triphenylmethane pigments, benzoquinone and naphthoquinone pigments, cyanine and azomethine pigments, indigoido pigments and bis-benzimidazole pigments. Among them, phthalocyanine pigments are preferred and titanyl phthalocyanine is more preferred. From the viewpoint of being a highly sensitive material, particularly preferred is a Y-type titanyl phthalocyanine with a crystal form having main peaks at Bragg angles 2θ of 9.6°±0.2°, 24.0°±0.2° and 27.2°±0.2° in an X-ray diffraction spectrum obtained using Cu-Kα rays.

The binder resin optionally used in the charge generation layer is not particularly limited and may be appropriately selected depending on the intended purpose. Examples thereof include polyamide resins, polyurethane resins, epoxy resins, polyketone resins, polycarbonate resins, silicone resins, acrylic resins, polyvinylbutylal resins, polyvinylformal resins, polyvinyl ketone resins, polystyrene resins, poly-N-vinylcarbazol resins and polyacrylamide resins. These may be used alone or in combination.

In addition to the above-listed binder resins, further examples of the binder resin include charge transporting polymers having a charge transporting function, such as polymer materials including polycarbonate resins (e.g., resins having an arylamine skeleton, a benzidine skeleton, a hydrazone skeleton, a carbazol skeleton, a stilbene skeleton and a pyrrazoline skeleton), polyester resins, polyurethane resins, polyether resins, polysiloxane resins and acrylic resins; and polymer materials having a polysilane skeleton.

The charge generation layer may further contain a low-molecular-weight charge transporting compound. The low-molecular-weight charge transporting compound is not particularly limited and may be appropriately selected depending on the intended purpose. Examples thereof include hole transporting compounds and electron transporting compounds.

The electron transporting compound is not particularly limited and may be appropriately selected depending on the intended purpose. Examples thereof include electron accepting compounds such as chloranil, bromanil, tetracyanoethylene, tetracyanoquinodimethane, 2,4,7-trinitro-9-fluorenone, 2,4,5,7-tetranitro-9-fluorenone, 2,4,5,7-tetranitroxanthone, 2,4,8-trinitrothioxanthone, 2,6,8-trinitro-4H-indeno[1,2-b]thiophen-4-one, 1,3,7-trinitrodibenzothiophene-5,5-dioxide and diphenoquinone derivatives. These may be used alone or in combination.

The hole transporting compound is not particularly limited and may be appropriately selected from known compounds depending on the intended purpose. Examples there of include electron donating compounds such as oxazole derivatives, oxadiazole derivatives, imidazole derivatives, monoarylamine derivatives, diarylamine derivatives, triarylamine derivatives, stilbene derivatives, α-phenylstilbene derivatives, benzidine derivatives, diarylmethane derivatives, triarylmethane derivatives, 9-styrylanthracene derivatives, pyrazoline derivatives, divinylbenzene derivatives, hydrazone derivatives, indene derivatives, butadiene derivatives, pyrene derivatives, bis-stilbene derivatives and enamine derivatives. These may be used alone or in combination.

The method for forming the charge generation layer is not particularly limited and may be appropriately selected depending on the intended purpose. Examples thereof include a vacuum thin-film formation method and a casting method using a solution dispersion system.

The vacuum thin-film formation method is not particularly limited and may be appropriately selected depending on the intended purpose. Examples thereof include a vacuum vapor evaporation method, a glow discharge decomposition method, an ion plating method, a sputtering method, a reactive sputtering method and a CVD method. It is preferable to use the above-listed inorganic or organic materials.

The casting method is not particularly limited and may be appropriately selected depending on the intended purpose. Examples thereof include a method including: dispersing the above-listed organic or inorganic materials and an optionally-used binder resin in a solvent; appropriately diluting the obtained dispersion liquid; and coating the diluted dispersion liquid.

The solvent is not particularly limited and may be appropriately selected depending on the intended purpose. Examples thereof include tetrahydrofuran, dioxane, dioxolan, toluene, dichloromethane, monochlorobenzene, dichloroethane, cyclohexanone, cyclopentanone, anisole, xylene, methyl ethyl ketone, acetone, ethyl acetate and butyl acetate.

The method for the dispersing is not particularly limited and may be appropriately selected depending on the intended purpose. Examples thereof include a method in which the organic or inorganic materials are dispersed with a ball mill, an attritor, a sand mill or a beads mill.

When the casting method is employed, a leveling agent such as a dimethyl silicone oil or methylphenyl silicone oil may optionally used.

The method for the coating is not particularly limited and may be appropriately selected depending on the intended purpose. Examples thereof include a dip coating method, a spray coating method, a bead coating method and a ring coating method.

The thickness of the charge generation layer is not particularly limited and may be appropriately selected depending on the intended purpose. It is preferably 0.01 μm to 5 μm, more preferably 0.05 μm to 2 μm.

### —Charge Transport Layer—

The charge transport layer is a layer having a charge transporting function.

The surface layer is formed on the charge transport layer.

The method for forming the charge transport layer is not particularly limited and may be appropriately selected depending on the intended purpose. Examples thereof include a method in which at least a charge transporting compound having a charge transporting function and a binder resin are dissolved or dispersed in an appropriate solvent, the resultant solution or dispersion liquid is coated on the charge generation layer and dried, the formed layer is coated with a coating liquid containing the radical-polymerizable compound of the present invention and optionally containing filler, followed by crosslinking or curing with light energy emitted from an LED serving as a light source.

The thickness of the charge transport layer is not particularly limited and may be appropriately selected depending on the intended purpose, but is preferably 5 μm to 40 μm, more preferably 10 μm to 30 μm.

The charge transporting compound is not particularly limited and may be appropriately selected depending on the intended purpose. Examples thereof include the electron transporting compounds, the hole transporting compound and the charge transporting polymer described in relation to the charge generation layer.

The binder resin is not particularly limited and may be appropriately selected depending on the intended purpose. Examples thereof include thermoplastic resins and thermosetting resins such as polystyrene resins, styrene-acrylonitrile copolymers, styrene-butadiene copolymers, styrene-maleic anhydride copolymers, polyester resins, polyvinyl chloride resins, vinyl chloride-vinyl acetate copolymers, polyvinyl acetate resins, polyvinylidene chloride resins, polyarylate resins, phenoxy resins, polycarbonates, cellulose acetate resins, ethyl cellulose resins, polyvinyl butyral resins, polyvinyl formal resins, polyvinyl toluene resins, poly-N-vinylcarbazole resins, acrylic resins, silicone resins, epoxy resins, melamine resins, urethane resins, phenol resins and alkyd resins.

The solvent used for the coating of the charge transport layer is not particularly limited and may be appropriately selected depending on the intended purpose. Examples thereof include solvents similar to those used for the coating of the charge generation layer. Preferred are solvents which dissolve well the charge transporting compound and the binder resin. These may be used alone or in combination.

The method for the coating of the coating liquid for the charge transport layer is not particularly limited and may be appropriately selected depending on the intended purpose. Examples thereof include coating methods similar to those used for the coating of the charge generation layer.

The coating liquid for the charge transport layer may optionally contain a plasticizer and a leveling agent.

The plasticizer is not particularly limited and may be appropriately selected depending on the intended purpose, so long as it may be a plasticizer for common resins, such as dibutylphthalate and dioctyphthalate.

The amount of the plasticizer used is not particularly limited and may be appropriately selected depending on the intended purpose, but is preferably 0 parts by mass to 30 parts by mass per 100 parts by mass of the binder resin.

The leveling agent is not particularly limited and may be appropriately selected depending on the intended purpose. Examples thereof include silicone oils such as dimethylsilicone oil and methylphenylsilicone oil; and polymers and oligomers each having a perfluoroalkyl group in the side chain thereof.

The amount of the leveling agent used is not particularly limited and may be appropriately selected depending on the intended purpose, but is preferably 0 parts by mass to 1 part by mass per 100 parts by mass of the binder resin.

As described in the method for forming the surface layer, the thus-formed charge transport layer is coated with a coating liquid containing a radical polymerizable composition of the present invention, optionally dried, and irradiated with light energy using an LED light source to initiate curing reaction, whereby the surface layer is formed.

### <<Single-Layered Photoconductive Layer>>

The single-layered photoconductive layer is a layer having both a charge generating function and a charge transporting function.

The surface layer is formed on the single-layered photoconductive layer.

The method for forming the single-layered photoconductive layer is not particularly limited and may be appropriately selected depending on the intended purpose. Examples thereof include a method of coating and/or drying a liquid which is prepared by dissolving or dispersing in an appropriate solvent a charge generating compound having a charge generating function, a charge transporting compound having a charge transporting function, and a binder resin.

The single-layered photoconductive layer may optionally contain a plasticizer and a leveling agent.

The charge generating compound and the dispersion method therefor, the charge transporting compound, the plasticizer and the leveling agent may be the same as those described in relation to the charge generation layer and the charge transport layer.

The binder resin is not particularly limited and may be appropriately selected depending on the intended purpose. For example, the binder resin described for the charge transport layer may be mixed with the binder resin described for the charge generation layer.

The thickness of the single-layered photoconductive layer is not particularly limited and may be appropriately selected depending on the intended purpose, but is preferably 5 μm to 30 μm, more preferably 10 μm to 25 μm.

The thus-formed photoconductive layer is coated with a coating liquid containing the radical polymerizable compound and the charge generating compound, optionally dried, and irradiated with light energy using an LED light source to initiate curing reaction, whereby the surface layer is formed.

The amount of the charge generating compound contained in the single-layered photoconductive layer is not particularly limited and may be appropriately selected depending on the intended purpose, but is preferably 1% by mass to 30% by mass relative to the total amount of the photoconductive layer.

The amount of the binder resin contained in the single-layered photoconductive layer is not particularly limited and may be appropriately selected depending on the intended purpose, but is preferably 20% by mass to 80% by mass relative to the total amount of the photoconductive layer.

The amount of the charge transporting compound contained in the single-layered photoconductive layer is not particularly limited and may be appropriately selected depending on the intended purpose, but is preferably 10% by mass to 70% by mass.

### <Under Layer>

In the electrophotographic photoconductor of the present invention, an under layer may be provided between the electroconductive substrate and the photoconductive layer.

In general, the under layer is made mainly of resin.

Preferably, the resin to be contained in the under layer is highly resistant to a commonly-used organic solvent, in consideration of subsequent formation of the photoconductive layer using a solvent.

The resin to be contained in the under layer is not particularly limited and may be appropriately selected depending on the intended purpose. Examples thereof include water-soluble resins (e.g., polyvinyl alcohol, casein and sodium polyacrylate); alcohol-soluble resins (e.g., nylon copolymer resins and methoxymethylated nylon resins); and curable resins forming a three-dimensional network structure (e.g., polyurethane resins, melamine resins, phenol resins, alkyd-melamine resins and epoxy resins).

The under layer may contain fine pigment particles of a metal oxide such as titanium oxide, silica, alumina, zirconium oxide, tin oxide or indium oxide, for the purpose of, for example, preventing moire generation and reducing residual potential.

The under layer may be formed using the appropriate solvent and coating method similar to the formation of the photoconductive layer.

The under layer may also be formed of a silane coupling agent, a titanium coupling agent or a chromium coupling agent.

The under layer is not particularly limited and may be appropriately selected depending on the intended purpose. Examples thereof include: a method in which Al₂O₃ is allowed to undergo anodic oxidation to form the under layer; a method in which an organic compound (e.g., polyparaxylene (parylene)) or an inorganic compound (e.g., SiO₂, SnO₂, TiO₂, ITO or CeO₂) is used to form the under layer with the vacuum thin film forming method; and other known methods.

The thickness of the under layer is not particularly limited and may be appropriately selected depending on the intended purpose. It is preferably 5 μm or smaller.

### <<Addition of Antioxidant to Each Layer>>

In the present invention, for the purpose of improving environmental stability, especially, preventing reduction of sensitivity and increase in residual potential, an antioxidant may be incorporated into each of the surface layer, the charge generation layer, the charge transport layer and the under layer.

The antioxidant is not particularly limited and may be appropriately selected depending on the intended purpose. Examples thereof include phenol compounds, paraphenylenediamines, hydroquinones and organic phosphorus-containing compounds. These antioxidants are known as antioxidants for rubber, plastics and fats and oils, and their commercially available products can easily be obtained.

### —Phenol Compound—

The phenol compound is not particularly limited and may be appropriately selected depending on the intended purpose. Examples thereof include 2,6-di-t-butyl-p-cresol, butylated hydroxyanisole, 2,6-di-t-butyl-4-ethylphenol, stearyl-p-(3,5-di-t-butyl-4-hydroxyphenyl)propionate, 2,2′-methylene-bis-(4-methyl-6-t-butylphenol), 2,2′-methylene-bis-(4-ethyl-6-t-butylphenol), 4,4′-thiobis-(3-methyl-6-t-butylphenol), 4,4′-butylidenebis-(3-methyl-6-t-butylphenol), 1,1,3-tris-(2-methyl-4-hydroxy-5-t-butylphenyl)butane, 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionate]methane, bis[3,3′-bis(4′-hydroxy-3′-t-butylphenyl)butylic acid]glycol ester and tocopherols.

### —Paraphenylenediamine—

The paraphenylenediamine is not particularly limited and may be appropriately selected depending on the intended purpose. Examples thereof include N-phenyl-N′-isopropyl-p-phenylenediamine, N,N′-di-sec-butyl-p-phenylenediamine, N-phenyl-N-sec-butyl-p-phenylenediamine, N,N′-di-isopropyl-p-phenylenediamine and N,N′-dimethyl-N,N′-di-t-butyl-p-phenylenediamine.

### —Hydroquinone—

The hydroquinone is not particularly limited and may be appropriately selected depending on the intended purpose. Examples thereof include 2,5-di-t-octylhydroquinone, 2,6-didodecylhydroquinone, 2-dodecylhydroquinone, 2-dodecyl-5-chlorohydroquinone, 2-t-octyl-5-methylhydroquinone and 2-(2-octadecenyl)-5-methylhydroquinone.

### —Organic Phosphorus-Containing Compound—

The organic phosphorus-containing compound is not particularly limited and may be appropriately selected depending on the intended purpose. Examples thereof include triphenyl phosphine, tri(nonylphenyl)phosphine, tri(dinonylphenyl)phosphine, tricresylphosphine and tri(2,4-dibutylphenoxy)phosphine.

The amount of the antioxidant added is not particularly limited and may be appropriately selected depending on the intended purpose, but is preferably 0.01% by mass to 10% by mass relative to the total mass of the layer to which the antioxidant is added.

### (Method for Producing an Electrophotographic Photoconductor)

A method of the present invention for producing an electrophotographic photoconductor is a method for producing an electrophotographic photoconductor including a photoconductive layer and a surface layer laid over an electroconductive substrate.

The surface layer is a crosslinked layer cured by irradiating a composition containing the above radical polymerizable monomer having no charge transporting structure, the above radical polymerizable compound having a charge transporting structure, and the above photopolymerization initiator with light emitted from a LED serving as a light source.

<Peak Wavelength of the Light Emitted from the LED>

The peak wavelength of the light emitted from the LED is not particularly limited and may be appropriately selected depending on the intended purpose, but is preferably 400 nm or longer.

The absorption edge wavelength of the photopolymerization initiator is longer than the peak wavelength of the light emitted from the LED.

The absorption peak wavelength λ, of the radical polymerizable compound having a charge transporting structure is shorter than the peak wavelength of the light emitted from the LED.

The absorption edge wavelength of the radical polymerizable compound having a charge transporting structure is not particularly limited and may be appropriately selected depending on the intended purpose, but is preferably shorter than the peak wavelength of the light emitted from the LED.

### EXAMPLES

The present invention will next be described by way of Examples and Comparative Examples. However, the present invention should not be construed as being limited to Examples.

### <Measurement of Wavelength of Emitted Light>

The wavelength spectrum of a LED light source was measured using a spectroradiometer (USR-45V, product of USHIO Inc.).

### <Measuring Method for Absorbance>

A radical polymerizable compound having a charge transporting structure was dissolved in acetonitrile to prepare a 2.00×10⁻⁶ mol % solution. The absorbance of the radical polymerizable compound was measured using a UV-Vis-NIR spectrophotometer UV-3600 (product of Shimadzu Corporation). The cell made of fused quartz was used, and the optical path length of the cell was 1 cm.

The above-prepared solution was added to the cell and measured for absorbance As at an absorption peak wavelength λ before irradiation of light energy and absorption Ae at an absorption peak wavelength λ after irradiation of light energy, and the ratio (Ae/As) was calculated.

### <Synthesis of Radical Polymerizable Compound Having a Charge Transporting Structure>

The radical polymerizable compound having a charge transporting structure in the present invention can be synthesized by, for example, the method described in JP-B No. 3164426.

### (Synthesis of Hydroxyl Group-Substituted Triarylamine Compound (Having the Following Structural Formula B))

240 ml of sulfolane was mixed with 113.85 g (0.3 mol) of a methoxy group-substituted triarylamine compound (having the following Structural Formula A) and 138 g (0.92 mol) of sodium iodide, and the mixture was heated at 60° C. under nitrogen flow. Then, 99 g (0.91 mol) of trimethylchlorosilane was added dropwise to the resultant mixture for one hour, followed by stirring at about 60° C. for 4.5 hours to complete the reaction. About 1.5 L of toluene was added to the reaction mixture, and the resultant mixture was cooled to room temperature and washed repeatedly with water and an aqueous sodium carbonate solution. Thereafter, the solvent was removed from the toluene solution and the residue was purified through column chromatography (adsorption medium: silica gel, developing solvent: mixture of toluene and ethyl acetate in a mixing ratio (toluene:ethyl acetate) of 20:1). The obtained pole yellow oily matter was mixed with cyclohexane and crystals were precipitated, to thereby obtain 88.1 g of white crystals of a compound having the following Structural Formula B (yield: 80.4%, melting point: 64.0° C. to 66.0° C.).

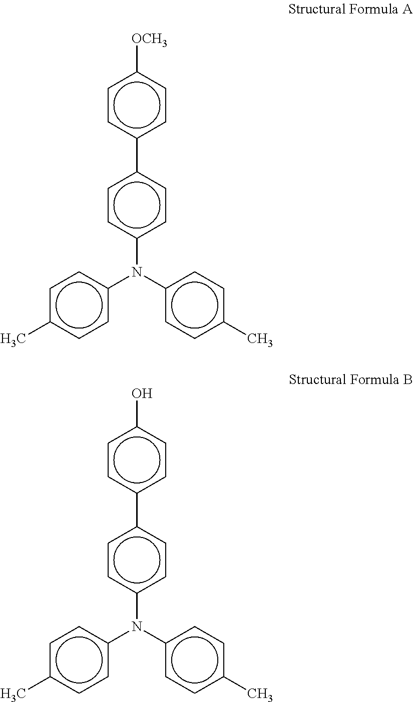

TABLE 1

| Elemental | | | |
|---|---|---|---|
| analysis (%) | C | H | N |
| Found | 85.06 | 6.41 | 3.73 |
| Calculated | 85.44 | 6.34 | 3.83 |

### (Synthesis of Triarylamino Group-Substituted Acrylate Compound (Having the Following Structural Formula C)

82.9 g (0.227 mol) of the above-synthesized hydroxyl group-substituted triarylamine compound (Structural Formula B) was dissolved in 400 mL of tetrahydrofuran, and an aqueous sodium hydroxide solution (NaOH: 12.4 g, water: 100 mL) was added dropwise to the solution under nitrogen flow. The resultant solution was cooled to 5° C., and 25.2 g (0.272 mol) of acrylic acid chloride was added dropwise to the solution for 40 minutes, followed by stirring at 5° C. for 3 hours to complete the reaction. The reaction mixture was poured into water and the resultant mixture was extracted with toluene. The obtained extract was washed repeatedly with an aqueous sodium hydrogencarbonate solution and water. Thereafter, the solvent was removed from the toluene solution, and the residue was purified through column chromatography (adsorption medium: silica gel, developing solvent: toluene). The obtained colorless oily matter was mixed with n-hexane and crystals were precipitated, to thereby obtain 80.73 g of white crystals of a compound having Structural Formula C (yield: 84.8%, melting point: 117.5° C. to 119.0° C., absorption edge wavelength: 400 nm, absorption peak wavelength: 330 nm).

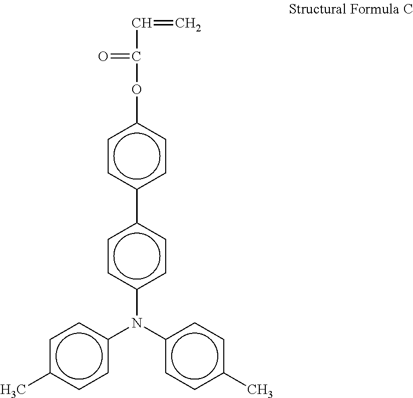

TABLE 2

| Elemental | | | |
|---|---|---|---|
| Analysis (%) | C | H | N |
| Found | 83.13 | 6.01 | 3.16 |
| Calculated | 83.02 | 6.00 | 3.33 |

### Example 1

### Formation of Under Layer

An Al substrate (outer diameter: 100 mm) was coated with the following under layer-coating liquid by the dip method so that an under layer obtained after drying had a thickness of 3.5 μm.

### —Under Layer-Coating Liquid—

Alkyd resin: 6.5 parts

(BECKOSOL 1307-60-EL, product of DIC Corporation)

Melamine resin: 3.5 parts

(SUPER BECKAMINE G-821-60, product of DIC Corporation)

Titanium oxide: 60 parts

(CR-EL, product of ISHIHARA SANGYO KAISHA LTD.)

Methyl ethyl ketone: 90 parts

### <Formation of Charge Generation Layer>

The thus-formed under layer was coated through dip coating with a charge generation layer-coating liquid containing a titanyl phthalocyanine pigment, to thereby form a charge generation layer having a thickness of 0.3 μm.

### —Charge Generation Layer-Coating Liquid—

Y-type titanyl phthalocyanine pigment: 2.0 parts

Polyvinyl butyral (BX-1, product of SEKISUI CHEMICAL CO., LTD.): 0.5 parts

Methyl ethyl ketone: 100 parts

### <Formation of Charge Transport Layer>

The thus-formed charge generation layer was coated through dip coating with the following charge transport layer-coating liquid, followed by drying with heating, to thereby form a charge transport layer having a thickness of 15 μm.

### —Charge Transport Layer-Coating Liquid—

Bisphenol Z-type polycarbonate: 9 parts

Charge transporting compound having the following Structural Formula 1:9 parts

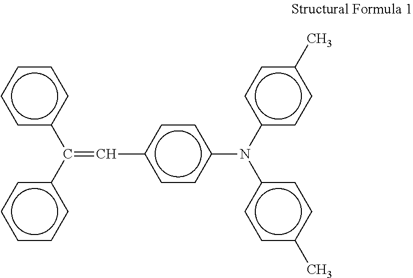

### <Formation of Surface Layer>

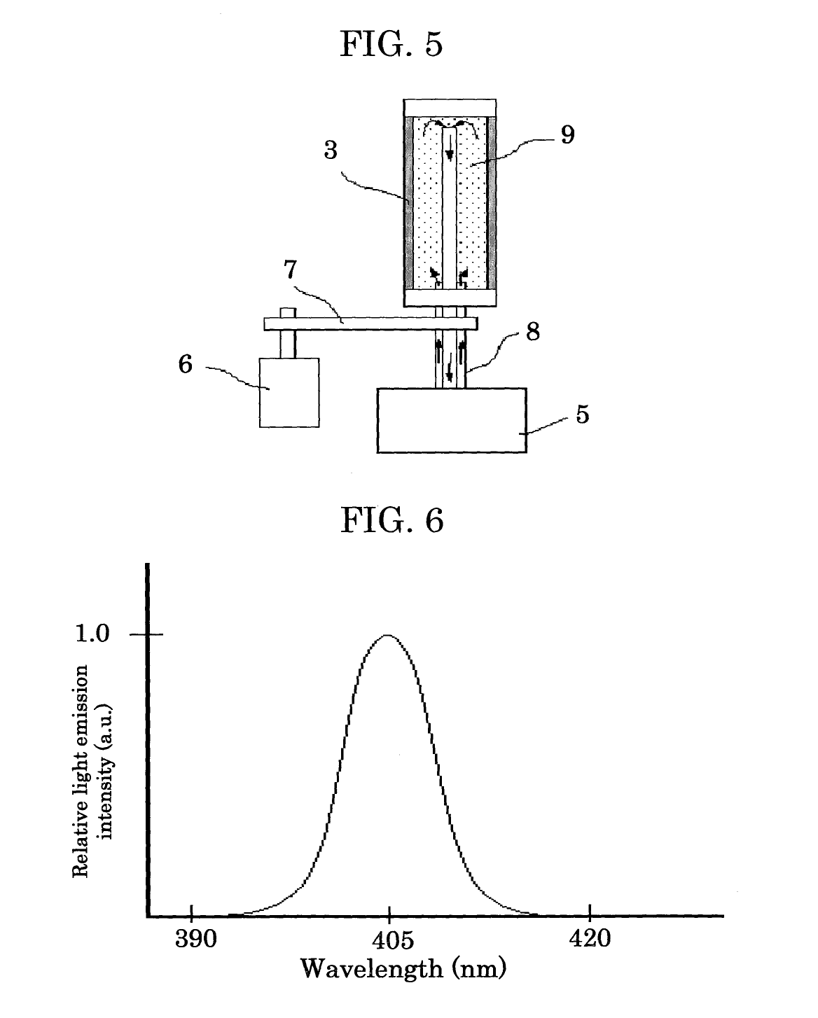

The thus-formed charge transport layer was coated through spray coating with the following surface layer-coating liquid. The obtained electrophotographic photoconductor drum was placed in an apparatus illustrated in FIG. 5 including a light energy irradiation vessel. The temperature of the thermostat bath was set to 40° C. and hot water was circulated to control the temperature of the photoconductor drum. While the photoconductor drum was being rotated, the photoconductor drum was irradiated with light using a LED light source (product of EYE GRAPHICS Co., Ltd.) having a light emission peak at 405 nm only. FIG. 6 is a wavelength spectrum of emission power of the LED.

While being rotated at 40 rpm, the photoconductor drum was irradiated with light under the following conditions: the illuminance on the photoconductor drum surface: 300 mW/cm², the distance between the photoconductor drum surface and the LED light source: 1 cm, and the irradiation time: 5 min. The photoconductor drum was dried at 130° C. for 30 min to form a surface layer having a thickness of 5 μm, whereby an electrophotographic photoconductor of the present invention was produced. The surface temperature of the photoconductor drum during the light irradiation was measured by contacting a thermocouple to the drum surface opposite to the light-irradiated drum surface.

### —Surface Layer-Coating Liquid—

Trimethylolpropane triacrylate (trifunctional acryl monomer): 5 parts (product name: SR351S, product of Sartomer Inc.)

Radical polymerizable compound having a charge transporting structure having the following Structural Formula C: 5 parts

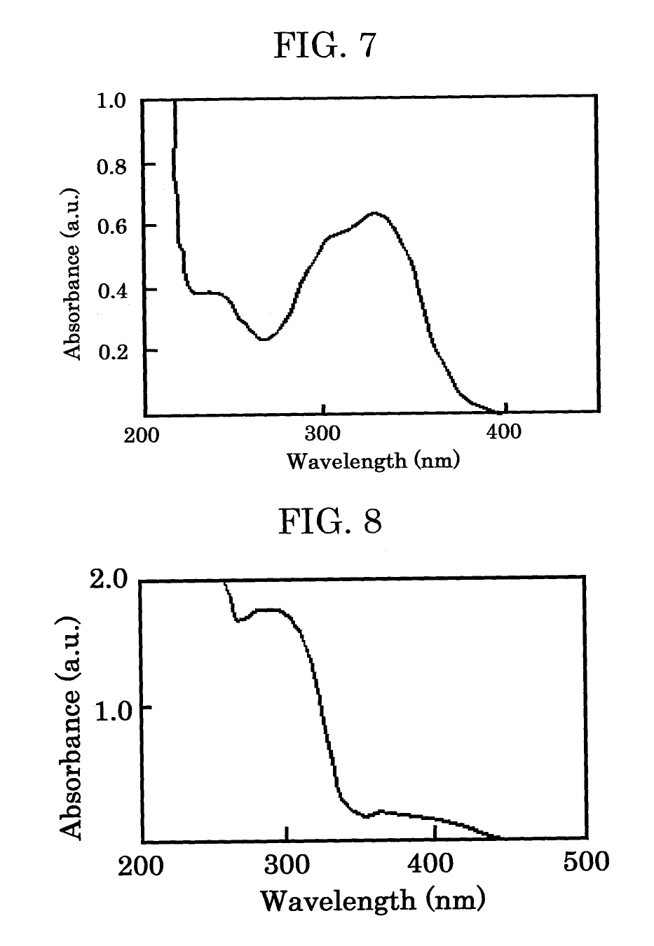

(absorption spectrum shown in FIG. 7: absorption edge wavelength: 400 nm, absorption peak wavelength: 330 nm)

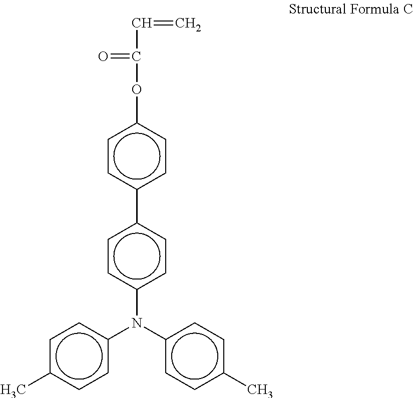

Photopolymerization initiator a (absorption spectrum shown in FIG. 8: absorption edge wavelength: 440 nm): 0.2 parts

Bis(2,4,6-trimethylbenzoyl)-phenylphosphine oxide

(IRGACURE 819, product of Ciba•Specialty•Chemicals)

Tetrahydrofuran: 70 parts

### <Measurement of Absorbance>

The radical polymerizable compound having a charge transporting structure having Structural Formula C was dissolved in acetonitrile, and the resultant solution was irradiated with light using a LED light source having a light emission peak at 405 nm only. The cell was attached to the rotating photoconductor drum surface. While being rotated, the cell was irradiated with light for 5 min with the distance between the cell surface and the LED light source was 1 cm. The absorbances measured before and after the light irradiation were used to calculate the absorbance ratio Ae/As.

### Example 2

An electrophotographic photoconductor was produced in the same manner as in Example 1 except that a LED having a peak wavelength of 395 nm was used.

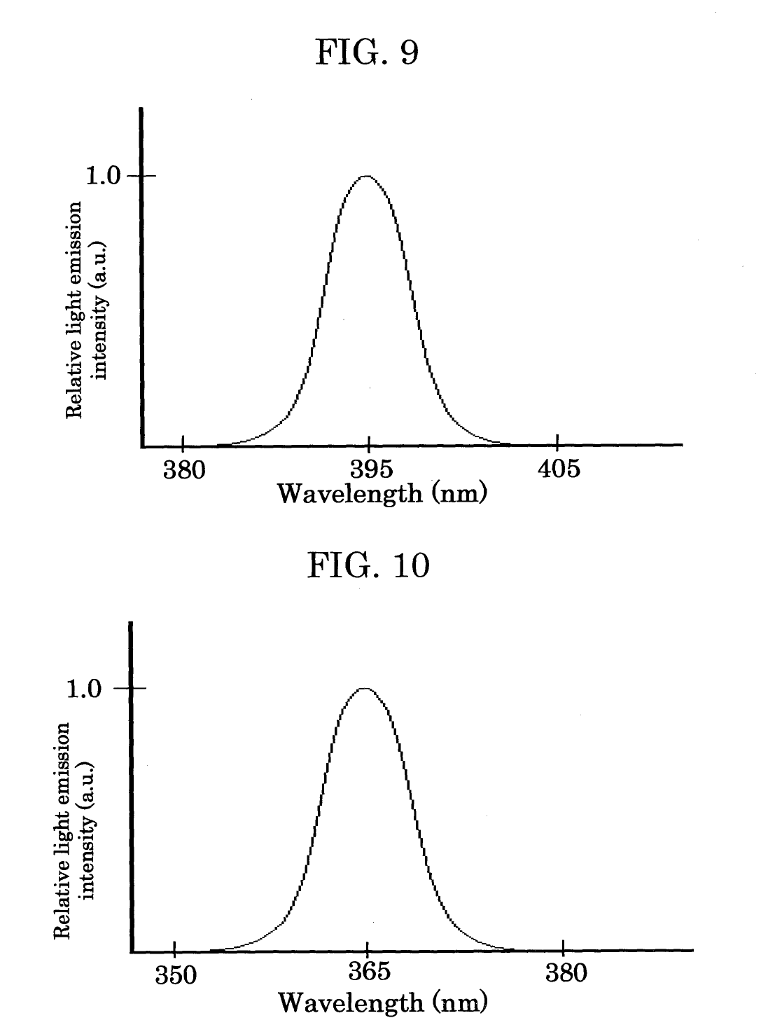

FIG. 9 is a wavelength spectrum of emission power of the LED.

### Example 3

An electrophotographic photoconductor was produced in the same manner as in Example 1 except that a LED having a peak wavelength of 375 nm was used.

### Example 4

An electrophotographic photoconductor was produced in the same manner as in Example 1 except that a LED having a peak wavelength of 365 nm was used.

FIG. 10 is a wavelength spectrum of emission power of the LED.

### Example 5

An electrophotographic photoconductor was produced in the same manner as in Example 1 except that the radical polymerizable compound having a charge transporting structure was changed to a compound having the following structure (Structural Formula D, absorption edge wavelength: 425 nm, absorption peak wavelength: 370 nm). The absorbances measured before and after the light irradiation were used to calculate the absorbance ratio Ae/As.

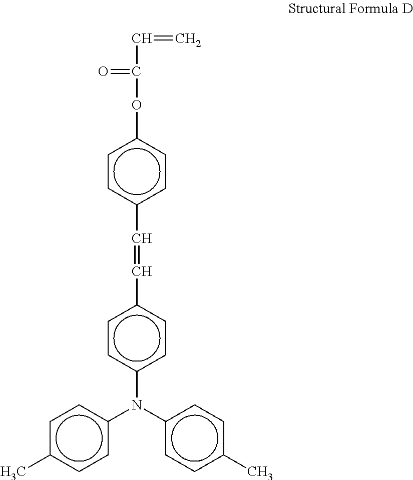

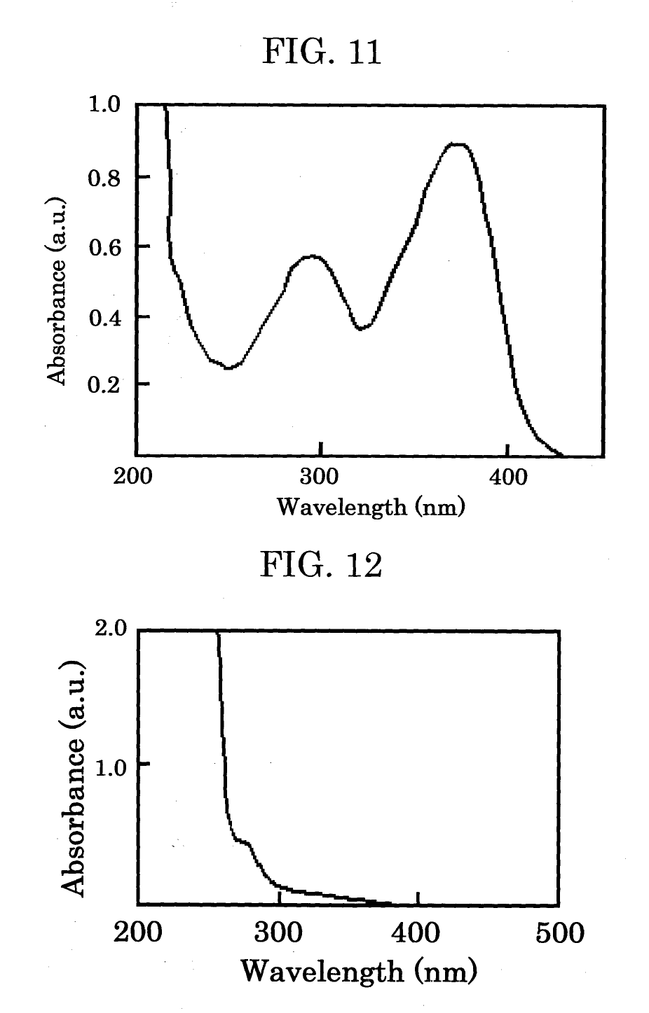

1 FIG. 11 shows an absorption spectrum of the compound having Structural Formula D.

### Example 6

An electrophotographic photoconductor was produced in the same manner as in Example 5 except that a LED having a peak wavelength of 395 nm was used.

### Example 7

An electrophotographic photoconductor was produced in the same manner as in Example 5 except that a LED having a peak wavelength of 375 nm was used.

### Comparative Example 1

An electrophotographic photoconductor was produced in the same manner as in Example 5 except that a LED having a peak wavelength of 365 nm was used.

### Example 8

An electrophotographic photoconductor was produced in the same manner as in Example 1 except that the radical polymerizable monomer having no charge transporting property used in the surface layer-coating liquid was changed to tetraethylene glycol diacrylate (difunctional acryl monomer) (product name: SR268, product of Sartomer Inc.).

### Example 9

An electrophotographic photoconductor was produced in the same manner as in Example 1 except that the radical polymerizable monomer having no charge transporting property used in the surface layer-coating liquid was changed to pentaerythritol tetraacrylate (tetrafunctional acryl monomer) (product name: SR295, product of Sartomer Inc.).

### Example 10

An electrophotographic photoconductor was produced in the same manner as in Example 5 except that the photopolymerization initiator a (absorption edge wavelength: 440 nm) was changed to photopolymerization initiator b (absorption edge wavelength: 380 nm) (1-hydroxy-cyclohexyl-phenyl-ketone, IRGACURE 184, product of Ciba•Specialty•Chemicals). FIG. 12 shows an absorption spectrum of the photopolymerization initiator b.

### Example 11

An electrophotographic photoconductor was produced in the same manner as in Example 10 except that a LED having a peak wavelength of 395 nm was used.

### Example 12

An electrophotographic photoconductor was produced in the same manner as in Example 10 except that a LED having a peak wavelength of 375 nm was used.

### Comparative Example 2

An electrophotographic photoconductor was produced in the same manner as in Example 10 except that a LED having a peak wavelength of 365 nm was used.

Each of the electrophotographic photoconductor produced in Examples 1 to 12 and Comparative Examples 1 to 2 was evaluated in the following manner. The evaluation results are shown in Tables 3 and 4.

### <Evaluation of Surface Conditions>

The surface layer before the following durability test was visually observed and evaluated for surface conditions.

### <Durability Test>

Each photoconductor was mounted in RICOH Pro 900 whose unexposed area potential was set to −900 V and was evaluated for image quality and measured for exposed area potential. After 500,000 A4 paper sheets had been caused to pass through the apparatus, the image evaluation and the exposed area potential measurement were performed. In addition, another 500,000 paper sheets were caused to pass therethrough and then the image evaluation and the exposed area potential measurement were performed. Furthermore, the thickness of the surface layer was measured before durability test (initial), after the pass of 500,000 paper sheets, and after the pass of 1,000,000 paper sheets, to thereby measure the abrasion amount resulting from the pass of the paper sheets. Notably, the thickness of the surface layer of the photoconductor was measured using an eddy-current film thickness meter (product of Fisher Instruments).

### [Image Evaluation]

A: No background smear was observed.

B: Background smear was observed slightly.

C: Background smear was observed partially.

D: Background smear was observed entirely.

TABLE 3

| | | Absorption edge | Absorption edge | Absorption peak | Number of | | | |
|---|---|---|---|---|---|---|---|---|
| | | wavelength of photo- | wavelength of | wavelength of | functional | | | |
| | LED peak | polymerization | polymerizable | polymerizable | group of | | | |
| | wavelength (nm) | initiator (nm) | compound (nm) | compound (nm) | monomer | As | Ae | Ae/As |
| Ex. 1 | 405 | 440 | 400 | 330 | 3 | 0.64 | 0.61 | 0.95 |
| Ex. 2 | 395 | 440 | 400 | 330 | 3 | 0.64 | 0.55 | 0.86 |
| Ex. 3 | 375 | 440 | 400 | 330 | 3 | 0.64 | 0.48 | 0.75 |
| Ex. 4 | 365 | 440 | 400 | 330 | 3 | 0.64 | 0.45 | 0.7 |
| Ex. 5 | 405 | 440 | 425 | 370 | 3 | 0.88 | 0.77 | 0.88 |
| Ex. 6 | 395 | 440 | 425 | 370 | 3 | 0.88 | 0.69 | 0.78 |
| Ex. 7 | 375 | 440 | 425 | 370 | 3 | 0.88 | 0.62 | 0.7 |
| Comp. | 365 | 440 | 425 | 370 | 3 | 0.88 | 0.53 | 0.6 |
| Ex. 1 | | | | | | | | |
| Ex. 8 | 405 | 440 | 400 | 330 | 2 | 0.64 | 0.59 | 0.92 |
| Ex. 9 | 405 | 440 | 400 | 330 | 4 | 0.64 | 0.6 | 0.94 |
| Ex. 10 | 405 | 380 | 425 | 370 | 3 | 0.88 | 0.77 | 0.88 |
| Ex. 11 | 395 | 380 | 425 | 370 | 3 | 0.88 | 0.69 | 0.78 |
| Ex. 12 | 375 | 380 | 425 | 370 | 3 | 0.88 | 0.62 | 0.7 |
| Comp. | 365 | 380 | 425 | 370 | 3 | 0.88 | 0.53 | 0.6 |
| Ex. 2 | | | | | | | | |

TABLE 4

| | | Image evaluation | | | Exposed area potential (−V) | | | Abrasion amount (μm) | |
|---|---|---|---|---|---|---|---|---|---|
| | Surface | | After 5 × 10⁵ | After 1 × 10⁶ | | After 5 × 10⁵ | After 1 × 10⁶ | After 5 × 10⁵ | After 1 × 10⁶ |
| | conditions | Initial | paper sheets | paper sheets | Initial | paper sheets | paper sheets | paper sheets | paper sheets |
| Ex. 1 | Good | A | A | A | 140 | 155 | 170 | 1.2 | 2.3 |
| Ex. 2 | Good | A | B | B | 160 | 180 | 210 | 1.4 | 2.9 |
| Ex. 3 | Good | A | B | C | 185 | 215 | 285 | 2.0 | 3.9 |
| Ex. 4 | Good | A | B | C | 195 | 230 | 315 | 2.4 | 4.9 |
| Ex. 5 | Good | A | B | B | 165 | 195 | 250 | 1.6 | 3.1 |
| Ex. 6 | Good | A | B | B | 180 | 225 | 300 | 2.2 | 4.2 |
| Ex. 7 | Good | A | B | C | 200 | 240 | 315 | 2.5 | 4.8 |
| Comp. | Good | C | D | D | 215 | 270 | 395 | 3.2 | 5.4 |
| Ex. 1 | | | | | | | | | |
| Ex. 8 | Good | A | B | C | 140 | 160 | 175 | 2.1 | 3.9 |
| Ex. 9 | Good | A | A | A | 145 | 160 | 180 | 0.8 | 1.6 |
| Ex. 10 | Good | A | B | C | 185 | 215 | 260 | 2.0 | 3.9 |
| Ex. 11 | Good | B | B | C | 190 | 225 | 300 | 2.2 | 4.4 |
| Ex. 12 | Good | B | C | C | 195 | 220 | 310 | 2.5 | 5.3 |
| Comp. | Rough | C | D | D | 195 | 280 | 375 | 4.8 | 12.7 |
| Ex. 2 | | | | | | | | | |

Aspects of the present invention are as follows.

<1> An electrophotographic photoconductor including:

an electroconductive substrate;

a photoconductive layer; and

a surface layer,

the photoconductive layer and the surface layer being laid over the electroconductive substrate,

wherein the surface layer is a crosslinked layer which is cured by irradiating with light energy a composition containing a radical polymerizable monomer having no charge transporting structure, a radical polymerizable compound having a charge transporting structure and a photopolymerization initiator, and

wherein the radical polymerizable compound having a charge transporting structure has a ratio Ae/As of 0.7 or higher where Ae denotes absorbance at an absorption peak wavelength λ after the radical polymerizable compound having a charge transporting structure is irradiated with light energy and As denotes absorbance at an absorption peak wavelength λ before the radical polymerizable compound having a charge transporting structure is irradiated with light energy.

<2> The electrophotographic photoconductor according to <1>, wherein the ratio Ae/As of the absorbance Ae to the absorbance As is 0.9 or higher.

<3> The electrophotographic photoconductor according to <1> or <2>, wherein the radical polymerizable compound having a charge transporting structure has an absorption edge wavelength of 400 nm or shorter, and the photopolymerization initiator has an absorption edge wavelength of 400 nm or longer.

<4> The electrophotographic photoconductor according to any one of <1> to <3>, wherein the photopolymerization initiator is an acylphosphineoxide compound.

<5> The electrophotographic photoconductor according to any one of <1> to <4>, wherein the radical polymerizable monomer having no charge transporting structure has three or more functional groups, and the radical polymerizable compound having a charge transporting structure has one functional group.

<6> A method for producing an electrophotographic photoconductor which includes a photoconductive layer and a surface layer laid over an electroconductive substrate, the method including:

irradiating a composition containing a radical polymerizable monomer having no charge transporting structure, a radical polymerizable compound having a charge transporting structure, and a photopolymerization initiator with light emitted from a LED serving as a light source, to thereby cure the composition to form a crosslinked layer which is the surface layer of the electrophotographic photoconductor,

wherein the radical polymerizable compound has an absorption peak wavelength λ shorter than a peak wavelength of the light emitted from the LED, and the photopolymerization initiator has an absorption edge wavelength longer than the peak wavelength of the light emitted from the LED.

<7> The method according to <6>, wherein the radical polymerizable compound having a charge transporting structure has an absorption edge wavelength shorter than the peak wavelength of the light emitted from the LED.

<8> The method according to <6> or <7>, wherein the peak wavelength of the light emitted from the LED is 400 nm or longer, the absorption edge wavelength of the radical polymerizable compound having a charge transporting structure is 400 nm or shorter, and the absorption edge wavelength of the photopolymerization initiator is 400 nm or longer.

<9> The method according to any one of <6> to <8>, wherein the photopolymerization initiator is an acylphosphineoxide compound.

<10> The method according to any one of <6> to <9>, wherein the radical polymerizable monomer having no charge transporting structure has three or more functional groups, and the radical polymerizable compound having a charge transporting structure has one functional group.

### REFERENCE SIGNS LIST

1 Printed wiring board
2 LED element
3 Photoconductor drum
4 Reflection plate
5 Thermostat bath
6 Motor
7 Belt
8 Double pipe
9 Heat medium
31 Electroconductive substrate
33 Photoconductive layer
35 Charge generation layer
37 Charge transport layer
39 Crosslinked surface layer

1. An electrophotographic photoconductor comprising:
an electroconductive substrate;
a photoconductive layer; and
a surface layer,
wherein
the photoconductive layer and the surface layer are laid over the electroconductive substrate,
the surface layer is a crosslinked layer which is cured by irradiating with light energy a composition comprising a radical polymerizable monomer having no charge transporting structure, a radical polymerizable compound having a charge transporting structure and a photopolymerization initiator, and
the radical polymerizable compound having a charge transporting structure has a ratio Ae/As of 0.7 or higher,
wherein
Ae denotes absorbance at an absorption peak wavelength λ after the radical polymerizable compound having a charge transporting structure is irradiated with light energy and
As denotes absorbance at an absorption peak wavelength λ before the radical polymerizable compound having a charge transporting structure is irradiated with light energy.

2. The electrophotographic photoconductor according to claim 1, wherein the ratio Ae/As of the absorbance Ae to the absorbance As is 0.9 or higher.

3. The electrophotographic photoconductor according to claim 1, wherein the radical polymerizable compound having a charge transporting structure has an absorption edge wavelength of 400 nm or shorter, and the photopolymerization initiator has an absorption edge wavelength of 400 nm or longer.

4. The electrophotographic photoconductor according to claim 1, wherein the photopolymerization initiator is an acylphosphineoxide compound.

5. The electrophotographic photoconductor according to claim 1, wherein the radical polymerizable monomer having no charge transporting structure has three or more functional groups, and the radical polymerizable compound having a charge transporting structure has one functional group.

6. A method for producing an electrophotographic photoconductor comprising a photoconductive layer and a surface layer laid over an electroconductive substrate, the method comprising:
irradiating a composition comprising a radical polymerizable monomer having no charge transporting structure, a radical polymerizable compound having a charge transporting structure, and a photopolymerization initiator with light emitted from a LED which is a light source, to thereby cure the composition to form a crosslinked layer which is the surface layer of the electrophotographic photoconductor,
wherein
the radical polymerizable compound has an absorption peak wavelength λ shorter than a peak wavelength of the light emitted from the LED, and the photopolymerization initiator has an absorption edge wavelength longer than the peak wavelength of the light emitted from the LED.

7. The method according to claim 6, wherein the radical polymerizable compound having a charge transporting structure has an absorption edge wavelength shorter than the peak wavelength of the light emitted from the LED.

8. The method according to claim 6, wherein the peak wavelength of the light emitted from the LED is 400 nm or longer, the absorption edge wavelength of the radical polymerizable compound having a charge transporting structure is 400 nm or shorter, and the absorption edge wavelength of the photopolymerization initiator is 400 nm or longer.

9. The method according to claim 6, wherein the photopolymerization initiator is an acylphosphineoxide compound.

10. The method according to claim 6, wherein the radical polymerizable monomer having no charge transporting structure has three or more functional groups, and the radical polymerizable compound having a charge transporting structure has one functional group.
